(19) United States
(12) Patent Application Publication
(10) Pub. No.: US 2018/0329208 A1
(43) Pub. Date: Nov. 15, 2018

(54) LIGHT GUIDE AND VIRTUAL IMAGE DISPLAY DEVICE

(71) Applicant: SHARP KABUSHIKI KAISHA, Sakai City, Osaka (JP)

(72) Inventor: TAKESHI MASUDA, Sakai City (JP)

(21) Appl. No.: 15/773,336

(22) PCT Filed: Oct. 27, 2016
(86) PCT No.: PCT/JP2016/081838

§ 371 Date: May 3, 2018

(30) Foreign Application Priority Data
Nov. 6, 2015 (JP) 2015-218504

(51) Int. Cl. G02B 27/01; G02B 27/14

(52) U.S. Cl. CPC G02B 27/0101; G02B 6/00; G02B 27/143

(57) ABSTRACT

A lightguide includes: a coupling structure (32) having a light-receiving surface to receive a light beam from a display element (10); and a light guide plate (32) which includes a first light-guiding layer (33A) having a prism surface (35) that is disposed so as to partially transmit the light beam entering from the coupling structure and propagating therein, and which includes a second light-guiding layer (33B) covering the prism surface, the light guide plate having an outgoing surface (S1) via which the light beam having been transmitted through the prism surface is allowed to exit. A refractive index of the coupling structure (32) is different from a refractive index of the light guide plate (32).

### TECHNICAL FIELD

This disclosure relates to a lightguide and a virtual image display apparatus incorporating the same.

### BACKGROUND ART

In recent years, virtual image display apparatuses have been being developed which magnify and display images, formed by a small-size display element, as virtual images. Virtual image display apparatuses include, for example, head-mounted displays (hereinafter referred to as “HMDs”) and head-up displays (hereinafter referred to as “HUDs”). A virtual image display apparatus is constructed so as to project light, which has been emitted by a display element, in the direction of a viewer's eye by using a light guide plate, a combiner, etc. A virtual image display apparatus of the see-through type is able to display virtual images of images formed by the display element, such that they are superposed on the landscape of the exterior as is visible through the light guide plate and the combiner. Using such a virtual image display apparatus allows to easily provide an AR (Augmented Reality) environment.

Patent Document 1 discloses a microdisplay system having a transmissive plate, a microdisplay engine, and a coupler. The microdisplay engine collimates displaying light from a display element by using a lens system, so as to generate a virtual image. The collimated light, having been introduced through the coupler into the transmissive plate, propagates by repeating total reflections through the interior of the transmissive plate, reflects off specular reflective surfaces formed on a transmissive plate surface, and exits from the transparent plate to the exterior. The out-going light beam reaches a viewer's pupil.

The microdisplay engine is positioned so that the optical axis thereof is inclined at an angle α_{c} with respect to the normal direction of the transmissive plate surface. On the other hand, the light-receiving surface of the coupler is inclined at the angle α_{c} with respect to the transmissive plate surface. As a result, the optical axis of the microdisplay engine is orthogonal to the light-receiving surface of the coupler. The refractive index of the transmissive plate is equal to that of the coupler.

A specular reflective surface formed on the transmissive plate surface has an angle φ of inclination with respect to the surface. Collimated light which is incident at the angle α_{c} on that surface from the vicinity of the optical axis of the microdisplay engine and which reflects off the surface and propagates through the interior will be reflected off the specular reflective surfaces to exit in the normal direction of the transmissive plate surface. In Patent Document 1, the angle α_{c} is set to equal 2φ, while φ=26° and α_{c}=52° are respectively specified as their preferable angles.

### CITATION LIST

### Patent Literature

Patent Document 1: the specification of U.S. Pat. No. 8,059,342

### SUMMARY OF INVENTION

### Technical Problem

However, a study by the inventors has found that, when the microdisplay system of Patent Document 1 is applied in the form of spectacles like an HMD, the coupler and microdisplay engine may come in the viewer's field of view, leading to the problem of narrowing the field of view regarding the periphery. This is because, as described above, the microdisplay engine is positioned so that the optical axis thereof is inclined at the angle α_{c} (i.e., 52°) with respect to the normal direction of the transmissive plate surface.

In order to avoid narrowing of the field of view, it might be possible, for example, to increase the overall length of the transmissive plate and dispose the coupler and microdisplay engine so as to be spaced away from the pupils in a direction along the front of the viewer's face. However, that would cause the coupler and microdisplay engine to appear protruding from the face, as viewed from the front of the face. Such positioning ends up ruining the aesthetics of the virtual image display apparatus, i.e., the HMD. On the other hand, prioritizing the aesthetics of the HMD causes the coupler and microdisplay engine to be in the viewer's field of view, thus ending up narrowing the field of view regarding the periphery.

Therefore, an objective of this disclosure is to provide a lightguide and a virtual image display apparatus incorporating the same which conserve a viewer's field of view without detracting from aesthetics.

### Solution to Problem

A lightguide according to an embodiment of the present invention comprises: a coupling structure having a light-receiving surface to receive a light beam from a display element; and a light guide plate which includes a first light-guiding layer having a prism surface that is disposed so as to partially transmit the light beam entering from the coupling structure and propagating therein, and which includes a second light-guiding layer covering the prism surface, the light guide plate having an outgoing surface via which the light beam having been transmitted through the prism surface is allowed to exit; wherein a refractive index of the coupling structure is different from a refractive index of the light guide plate.

In one embodiment, the coupling structure is disposed either on the outgoing surface of the light guide plate or on an opposite surface that is opposite to the outgoing surface; and the refractive index of the coupling structure is greater than the refractive index of the light guide plate.

In one embodiment, the prism surface has a plurality of first and a plurality of second slope surfaces; each of the plurality of first slope surfaces is inclined at a first slope angle φₚ with respect to the outgoing surface, and coated with a semi-reflective film which partially reflects a light beam propagating through an interior of the second light-guiding layer and partially transmits the light beam; each of the plurality of second slope surfaces is inclined at a second slope angle which is greater than the first slope angle φₚ with respect to the outgoing surface, and not coated with the semi-reflective film; and the relationship α_{c}<2φₚ is satisfied between the first slope angle φₚ and an angle α_{c} which the light-receiving surface of the coupling structure forms with the outgoing surface of the light guide plate.

In one embodiment, the refractive index of the coupling structure is greater than the respective refractive indices of the first light-guiding layer and the second light-guiding layer.

In one embodiment, the light guide plate further includes a first transparent substrate supporting the first light-guiding layer and a second transparent substrate supporting the second light-guiding layer, the second transparent substrate having the outgoing surface at an opposite side from a contact surface via which the second transparent substrate is in contact with the second light-guiding layer; the coupling structure contacts an end face of the light guide plate which is substantially orthogonal to a propagating direction of a light beam propagating through an interior of the light guide plate; and the refractive index of the coupling structure is smaller than the refractive index of the light guide plate.

In one embodiment, the refractive index of the coupling structure is smaller than a refractive index of at least one of the first transparent substrate, the second transparent substrate, the first light-guiding layer, and the second light-guiding layer.

In one embodiment, the refractive index of the first light-guiding layer is substantially equal to the refractive index of the second light-guiding layer.

In one embodiment, the light guide plate further includes a first transparent substrate supporting the first light-guiding layer and a second transparent substrate supporting the second light-guiding layer, the second transparent substrate having the outgoing surface at an opposite side from a contact surface via which the second transparent substrate is in contact with the second light-guiding layer.

In one embodiment, refractive indices of the first light-guiding layer, the second light-guiding layer, the first transparent substrate, and the second transparent substrate are substantially equal to one another.

In one embodiment, the prism surface has a plurality of first and a plurality of second slope surfaces; and each of the plurality of first slope surfaces is inclined at a first slope angle φₚ with respect to the outgoing surface, and coated with a semi-reflective film which partially reflects a light beam propagating through an interior of the second light-guiding layer and partially transmits the light beam; each of the plurality of second slope surfaces is inclined at a second slope angle which is greater than the first slope angle φₚ with respect to the outgoing surface, and not coated with the semi-reflective film.

In one embodiment, the refractive index of the first light-guiding layer is substantially equal to the refractive index of the second light-guiding layer while the refractive index of the first transparent substrate is substantially equal to the refractive index of the second transparent substrate.

In one embodiment, the refractive indices of the first and second transparent substrates are greater than the refractive indices of the first and second light-guiding layers.

In one embodiment, the second light-guiding layer is a planarization layer for planarizing the lens surface, the planarization layer having a substantially flat surface.

In one embodiment, the coupling structure and the light guide plate are mutually independent members.

A virtual image display apparatus according to an embodiment of the present invention comprises: an image processing circuit to horizontally reduce an input image; the display element to display the reduced image having been horizontally reduced; a collimating optical system to collimate displaying light emitted from the display element; and the above lightguide.

A virtual image display apparatus according to another embodiment of the present invention comprises: the display element; a collimating optical system to collimate displaying light emitted from the display element; and the above lightguide.

### Advantageous Effects of Invention

According to an embodiment of the present invention, there are provided a lightguide, and a virtual image display apparatus incorporating the same, which conserve a viewer's field of view without detracting from aesthetics.

### BRIEF DESCRIPTION OF DRAWINGS

FIG. 1A is a perspective view schematically illustrating the construction of a virtual image display apparatus 100 according to a first embodiment.

FIG. 1B is a plan view of the virtual image display apparatus 100.

FIG. 2A is a cross-sectional view of a light guide plate 30 as taken parallel to the XZ plane, schematically illustrating mainly the internal structure of the light guide plate 30.

FIG. 2B is a schematic diagram illustrating, enlarged, one of a plurality of prisms 35A in a prism reflection array 35.

FIG. 3A is a cross-sectional view of the light guide plate 30 in the XZ plane.

FIG. 3B is a schematic diagram illustrating how light is reflected off a semi-reflective film 35r in a prism 35A.

FIG. 3C is a schematic diagram illustrating how light is reflected off the semi-reflective film 35r in the prism 35A, with the horizontal angle of view (+θ_{H}) of the virtual image taken into account.

FIG. 3D is a schematic diagram illustrating how light is reflected off the semi-reflective film 35r in the prism 35A, with the horizontal angle of view (−θ_{H}) of the virtual image taken into account.

FIG. 4 is a schematic diagram illustrating how virtual-image projection light emitted from the display element 10 propagates through the interior of the light guide plate 30.

FIG. 5A is an external view of a die 200 to be used for producing a prism reflection array 35.

FIG. 5B is a schematic diagram illustrating how the shape of the die 200 may be transferred to a transparent molding member on a first transparent substrate 34A.

FIG. 6A is a cross-sectional view of a light guide plate 30 as taken parallel to the XZ plane, concerning a prism reflection array 35, illustrating how semi-reflective films 35r may be formed on the prism reflection array 35 through oblique vapor deposition.

FIG. 6B is a cross-sectional view of a light guide plate 30 as taken parallel to the XZ plane, the light guide plate 30 being obtained by attaching a first transparent substrate 34A and a second transparent substrate 34B to each other.

FIG. 7 schematically illustrates, in a variant of the light guide plate 30 of the first embodiment, a cross section of the light guide plate 30 being taken parallel to the XZ plane, at an end having a light receiving portion 31.

FIG. 8 is a schematic diagram illustrating a relative positioning between a viewer and a virtual image projection device 40 as seen from above the viewer's head, where the viewer wears a virtual image display apparatus 100.

FIG. 9 is a schematic diagram illustrating a state in which a virtual image display apparatus 100 is worn by a viewer so that the light guide plate 30 is inclined at an angle θ₀ with respect to the viewer.

FIG. 10A is a cross-sectional view of the light guide plate 30 in the XZ plane.

FIG. 10B is a schematic diagram illustrating how light is reflected off a semi-reflective film 35r in a prism 35A.

FIG. 10C is a schematic diagram illustrating how light is reflected off the semi-reflective film 35r in the prism 35A, with the horizontal angle of view (+θ_{H}) of the virtual image taken into account.

FIG. 10D is a schematic diagram illustrating how light is reflected off the semi-reflective film 35r in the prism 35A, with the horizontal angle of view (−θ_{H}) of the virtual image taken into account.

FIG. 11 is a schematic diagram illustrating how virtual-image projection light emitted from the display element 10 propagates through the interior of the light guide plate 30.

FIG. 12 is a schematic diagram illustrating a relative positioning between a viewer and a virtual image projection device 40 as seen from above the viewer's head, where the viewer wears a virtual image display apparatus 100.

FIG. 13 is a schematic diagram illustrating the construction of a virtual image display apparatus 100A according to a third embodiment.

FIG. 14A is a schematic diagram illustrating a virtual-image pattern displayed without input image correction.

FIG. 14B is a schematic diagram illustrating a virtual-image pattern displayed with input image correction.

FIG. 15 is a schematic diagram illustrating the construction of a virtual image display apparatus 100B according to a fourth embodiment.

FIG. 16A is a cross-sectional view of the light guide plate 30 in the XZ plane.

FIG. 16B is a schematic diagram illustrating how light is reflected off a semi-reflective film 35r in a prism 35A.

FIG. 16C is a schematic diagram illustrating how light is reflected off the semi-reflective film 35r in the prism 35A, with the horizontal angle of view (+θ_{H}) of the virtual image taken into account.

FIG. 16D is a schematic diagram illustrating how light is reflected off the semi-reflective film 35r in the prism 35A, with the horizontal angle of view (−θ_{H}) of the virtual image taken into account.

FIG. 17 is a schematic diagram illustrating how virtual-image projection light emitted from the display element 10 propagates through the interior of the light guide plate 30.

FIG. 18 is a schematic diagram illustrating a relative positioning between a viewer and a virtual image projection device 40 as seen from above the viewer's head, where the viewer wears a virtual image display apparatus 100B.

### DESCRIPTION OF EMBODIMENTS

Hereinafter, with reference to the drawings, lightguides according to embodiments of the present invention and virtual image display apparatuses incorporating the same will be described. As below, the construction of an HMD will be described as an exemplary virtual image display apparatus; however, the present invention is not limited thereto. Moreover, lightguides as will be described below are applicable not only to HMDs but also to other implementations of virtual image display apparatuses, such as HUDs, etc.

A lightguide according to an embodiment of the present invention includes: a coupling structure having a light-receiving surface to receive a light beam from a display element; and a light guide plate which includes a first light-guiding layer having a prism surface that is disposed so as to partially transmit the light beam entering from the coupling structure and propagating therein, and which includes a second light-guiding layer covering the prism surface, the light guide plate having an outgoing surface via which the light beam having been transmitted through the prism surface is allowed to exit. The refractive index of the coupling structure is different from that of the light guide plate. Preferably, the refractive index of the first light-guiding layer is substantially equal to that of the second light-guiding layer.

According to embodiments of the present invention, an angle α_{c} which the light-receiving surface of the coupling structure forms with the first outgoing surface of the light guide plate can be decreased relative to conventional lightguide structures.

### First Embodiment

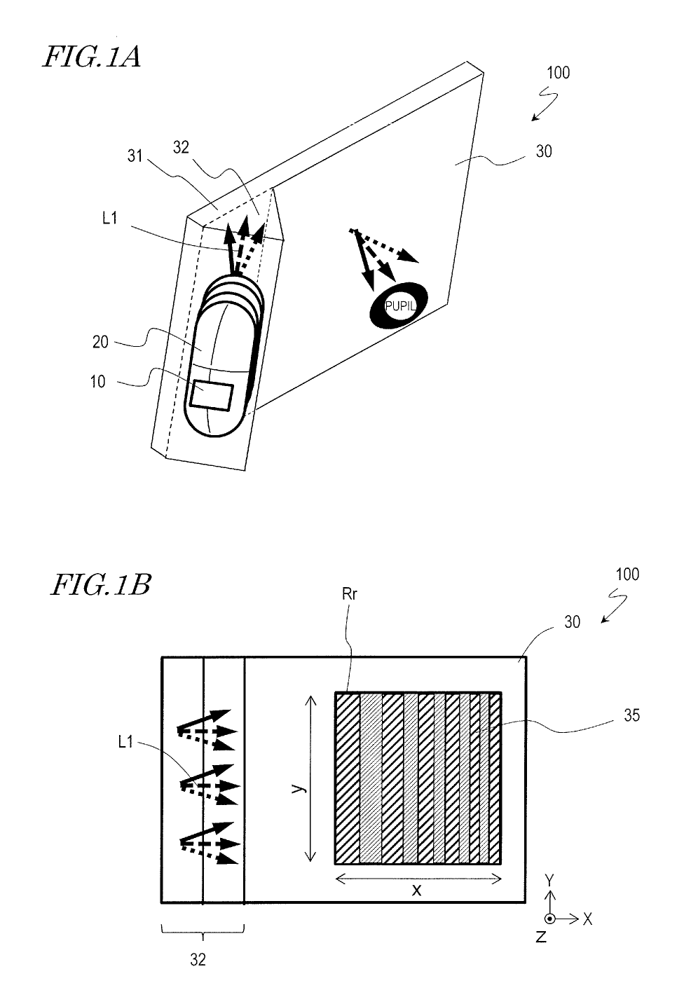

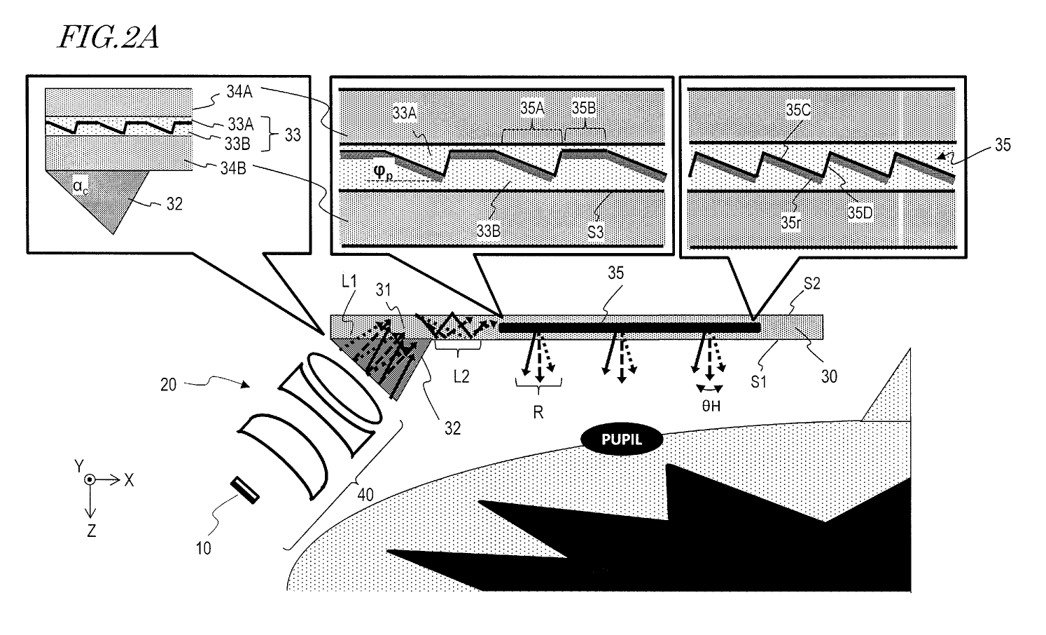

FIG. A is a perspective view schematically illustrating the construction of a virtual image display apparatus 100 according to a first embodiment. FIG. 1B is a plan view of the virtual image display apparatus 100.

The virtual image display apparatus 100 includes a display element 10, a projection lens system (collimating optical system) 20 which receives light emitted from the display element 10 and collimates it, and a light guide plate 30 with which to project toward a viewer the collimated light having exited from the projection lens system 20. The light guide plate 30 includes a prism reflection array 35 which partially reflects the collimated light propagating through the interior so that it goes out to the exterior.

At an end of one principal face of the light guide plate 30, a coupling structure 32 is provided to receive collimated light L1 (hereinafter simply referred to as the light L1) from the projection lens system 20. The present embodiment uses as the coupling structure 32 a triangular prism extending along an edge of the light guide plate 30 (i.e., along the Y direction shown in FIG. 1B). On the other hand, as illustrated in FIG. 1B, the prism reflection array 35 is disposed in a predetermined in-plane region that is within a plane parallel to an outgoing surface through which light is extracted. In the present embodiment, the prism reflection array 35 is disposed in a predetermined rectangular region Rr which has a width x along the X direction and a width y along the Y direction within the plane of the light guide plate 30. In the present specification, an optical element including the light guide plate 30 and the coupling structure 32 may be referred to as a “lightguide”.

In the virtual image display apparatus 100, the emission light (i.e., virtual image displaying light) L1 from the display element 10 is collimated by the projection lens system 20, and then enters the coupling structure 32 disposed at the end of the light guide plate 30. The collimated light having entered the coupling structure 32 propagates, while repeating total reflections, through the interior of the light guide plate 30 from a light receiving portion 31 of the light guide plate 30, which is the portion at which the coupling structure 32 is disposed, for example along the X direction shown in FIG. 1B (i.e., in an in-plane direction from the coupling structure 32 toward the opposing edge of the light guide plate 30).

Note that the light L1 to be introduced from the coupling structure 32 into the light guide plate 30 contains, as illustrated in FIGS. 1A and 1B, a plurality of light beams having different directions of travel according to pixel positions on the display element 10. For example, a light beam emitted from the central region of the display element 10 corresponds to a light beam traveling in a direction that is parallel to the X direction shown in FIG. 1B, whereas a light beam emitted from a peripheral region of the display element 10 corresponds to a light beam traveling in a direction non-parallel to the X direction.

As the display element 10 and the projection lens system 20, those which are known can be broadly used. For example, a transmission type liquid crystal display panel or an organic EL display panel may be used as the display element 10, while a lens system which is disclosed in e.g. Japanese Laid-Open Patent Publication No. 2004-157520 may be used as the projection lens system 20. Alternatively, a reflection type liquid crystal display panel (LCOS) may be used as the display element 10, while concave mirrors or lenses disclosed in e.g. Japanese Laid-Open Patent Publication No. 2010-282231 may be used as the projection lens system 20. The entire disclosures of Japanese Laid-Open Patent Publication No. 2004-157520 and Japanese Laid-Open Patent Publication No. 2010-282231 are incorporated herein by reference.

The display element 10 measures about 0.2 inches to about 0.5 inches diagonal, for example. Note that the diameter of a light beam to be emitted from the projection lens system 20 may be adjusted by the projection lens system 20. On the other hand, the size of a light beam to enter the light guide plate 30 is determined by the size of the coupling structure 32.

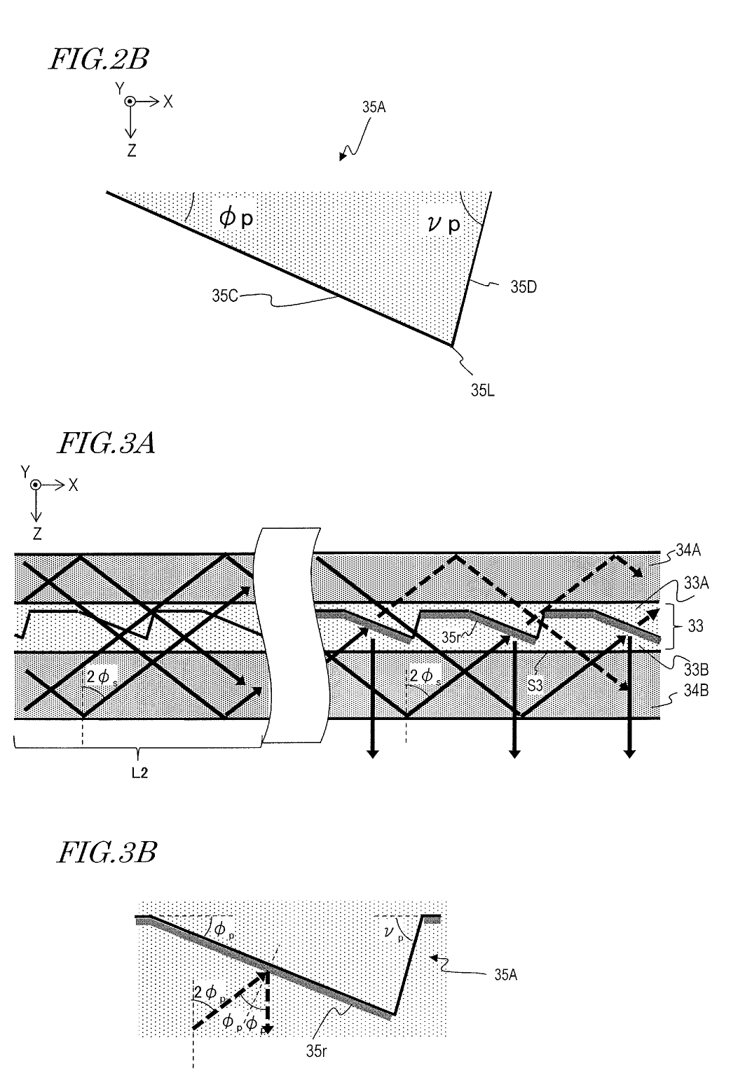

FIG. 2A schematically illustrates a cross section as taken parallel to the XZ plane, which mainly illustrates the internal structure of the light guide plate 30. The light guide plate 30 includes a first transparent substrate 34A, a second transparent substrate 34B, and a light-guiding layer 33 having a first light-guiding layer 33A and a second light-guiding layer 33B. In a state where the virtual image display apparatus 100 is worn by a viewer, the first transparent substrate 34A is located on the opposite side from the viewer, while the second transparent substrate 34B is located on the viewer's side. The first transparent substrate 34A and the second transparent substrate 34B are made of, for example, glass plates, transparent resin plates, etc., which are arranged so as to overlie each other. In the present specification, both the first transparent substrate 34A and the second transparent substrate 34B may be referred to as “transparent substrates”.

The light-guiding layer 33 is sandwiched between the first transparent substrate 34A and the second transparent substrate 34B. The thickness of the light-guiding layer 33 is chosen to be 0.1 mm to 0.5 mm, for example. The outer surface of the first transparent substrate 34A constitutes an upper (i.e., opposite side from the viewer) principal face S2 of the light guide plate 30, whereas the outer surface of the second transparent substrate 34B constitutes a lower (i.e., viewer's side) principal face S1 of the light guide plate 30. The lower principal face S1 and the upper principal face S2 of the light guide plate 30 are exposed to air. In the present specification, the principal faces of the light guide plate 30 may respectively be referred to as the upper principal face S2 and the lower principal face S1 according to the drawing, for convenience of distinction. However, it should be appreciated that they do not imply an upper-lower relative positioning in actual use.

Preferably, the refractive index of the first light-guiding layer 33A is substantially equal to that of the second light-guiding layer 33B, and preferably, the first light-guiding layer 33A and the second light-guiding layer 33B are made of an identical material. Now let nₚ denote the refractive index of the first and second light-guiding layers 33A and 33B (i.e., that of the light-guiding layer 33), and let n_{c} denote the refractive index of the coupling structure 32. In the present embodiment, the first light-guiding layer 33A and the second light-guiding layer 33B are made of an identical material, whereas the refractive index n_{c} of the coupling structure 32 is greater than the refractive index nₚ of the light-guiding layer 33. Since the coupling structure 32 and the light-guiding layer 33 have mutually different refractive indices, they may advantageously be prepared as distinct members. As will be described later, such a relationship between the refractive indices allows to decrease an angle α_{c} which the light-receiving surface of the coupling structure 32 forms with the lower principal face S1, relative to conventional lightguide structures.

As illustrated in FIG. 2A, around the middle of the thickness of the light guide plate 30, a prism reflection array 35 which includes a plurality of prisms 35A is provided. A light beam having entered the light guide plate 30 through the coupling structure 32 is partially reflected by the prism reflection array 35 so as to go out, as virtual-image reflection light R, to the exterior through an outgoing surface S1 of the light guide plate 30. The prism reflection array 35 is constructed so as to allow the light beam to go out principally in the normal direction of the outgoing surface S1. The light-guiding layer 33 also has an outgoing surface S3 that is substantially parallel to the outgoing surface S1. Note that the outgoing surface S1 corresponds to the lower principal face S1 of the light guide plate 30. The normal directions of the outgoing surfaces S1 and S3 are the Z direction, which is orthogonal to the X direction and the Y direction shown in FIG. 1.

The prism reflection array 35 is disposed in the light-guiding layer 33. The first light-guiding layer 33A, which has a prism surface as will be described later, is supported by the first transparent substrate 34A. The second light-guiding layer 33B is supported by the second transparent substrate 34B. In the present embodiment, the prism reflection array 35 is provided on the inner surface of the first transparent substrate 34A; however, the prism reflection array 35 may be provided on the inner surface of the second transparent substrate 34B. The first transparent substrate 34A and the second transparent substrate 34B have substantially rectangular shapes, whose outer sizes may be chosen to be 45 mm×30 mm, for example. The thicknesses of the first transparent substrate 34A and the second transparent substrate 34B fall within a range of not less than 0.5 mm and not more than 2.0 mm, for example.

The prism reflection array 35 is covered with the second light-guiding layer 33B. One face of the second light-guiding layer 33B has a shape that matches the shapes of the prisms 35A formed in the first light-guiding layer 33A; its opposite face has a plane that is parallel to a principal face of the light guide plate 30, i.e., the lower principal face S1 of the second light-guiding layer 33B. The second light-guiding layer 33B is a member for planarizing the surface of the prism reflection array 35, disposed so as to bury the rugged features. Hereinafter, a detailed structure of the prism reflection array 35 will be described.

FIG. 2B illustrates, enlarged, one of the plurality of prisms 35A in the prism reflection array 35. The prism 35A includes a first slope surface 35C and a second slope surface 35D. The first slope surface 35C and the second slope surface 35D form a ridge 35L. The first slope surface 35C is inclined at a slope angle φₚ with respect to the outgoing surface S1 of the light guide plate 30. The second slope surface 35D is inclined at a slope angle νₚ which is greater than the angle φₚ with respect to the outgoing surface S1. In the prism 35A, the second slope surface 35D is located on the side that is farther from the light receiving portion 31 than is the first slope surface 35C. The height of the prism 35A (the distance from the bottom face to the apex) is chosen to be 0.1 mm to 0.5 mm, for example.

As depicted in FIG. 2B, consider a cross section in the light guide plate 30 where the direction from the end having the light receiving portion 31 toward the other end is defined as the positive X direction. In this cross section, with the XY plane taken as reference (0°) and with the clockwise direction defined as positive, the slope angle φₚ of the first slope surface 35C is designated; with the counterclockwise direction defined as positive, the slope angle νₚ of the second slope surface 35D is designated.

See FIG. 2A again. The first slope surface 35C is coated with a semi-reflective film 35r, whereas the second slope surface 35D is not coated with any semi-reflective film 35r. The prism reflection array 35 refers to an array of a plurality of semi-reflective films 35r formed on a plurality of first slope surfaces 35C. The film thickness of a semi-reflective film 35r generally ranges from several nm to several hundred nm.

According to the present embodiment, in the prism reflection array 35, at positions near the coupling structure 32 (or the light receiving portion 31), slit-like flat portions (hereinafter referred to as “parallel surfaces”) 35B are provided between adjacent prisms 35A. On the other hand, at positions far from the coupling structure 32, there are no parallel surfaces 35B as described above provided between adjacent prisms 34A, but the prisms 35A are closely and contiguously arranged. The parallel surfaces 35B also are coated with the semi-reflective films 35r.

The semi-reflective films 35r are made of e.g. thin metal films (Ag films, Al films, etc.) or dielectric films (TiO₂ films, etc.), so as to be capable of partially reflecting an incident light beam while partially transmitting the light beam. In the present specification, the interface between the first light-guiding layer 33A and the second light-guiding layer 33B, which includes the first slope surfaces 35C, the second slope surfaces 35D, and the parallel surfaces 35B, may be referred to as a “prism surface”.

Since the second slope surfaces 35D are left uncoated with the semi-reflective films 35r, a light beam (propagating light L2) propagating through the interior of the light guide plate 30 is reflected at the first slope surfaces 35C and the parallel surfaces 35B of the prisms 35A, but not reflected at the second slope surfaces 35D. The reason why the second slope surfaces 35D alone are left uncoated is that, if the second slope surfaces 35D were semi-reflective surfaces, the light would be reflected in unexpected directions to become stray light, thus making it more difficult to perform high-quality virtual image displaying.

As described above, on the prism surface, by selectively coating the first slope surfaces 35C and the parallel surfaces 35B alone with the semi-reflective films 35r, it is possible to cause the light propagating through the interior of the light guide plate 30 to be partially reflected off the first slope surfaces 35C and the parallel surfaces 35B, while allowing the light which is incident from outside the upper principal face S2 of the light guide plate 30 (i.e., the light from the exterior) to exit through the lower principal face S1 of the light guide plate 30.

Now the reason why the array patterns of the prisms are, as described above, varied according to their positions in the prism reflection array 35 will be explained. When a light beam having reflected off the prism reflection array 35 exits from the light guide plate 30, the outgoing surface S1 may in some cases be observed to vary in brightness from position to position. One presumable cause thereof is that a uniform in-plane distribution of the reflecting surfaces in the prism reflection array 35, which is disposed in the light guide plate 30, will lead to a relatively higher intensity of the collimated light exiting on the side that is closer to the light receiving portion 31 (on which the light from the display element 10 is incident) and a relatively lower intensity of the collimated light exiting on the farther side.

Therefore, the prism reflection array 35 according to the present embodiment employs a construction in which the area ratio of the first slope surfaces 35C per unit area on the outgoing surface is varied according to position in the outgoing surface. More specifically, within the region where the prism reflection array 35 is disposed, on the side that is closer to the coupling structure 32 (or to the light receiving portion 31 of the light guide plate 30), a parallel surface 35B is provided between two adjacent prisms 35A so that the area ratio of the first slope surfaces 35C is set relatively low. On the other hand, on the side farther from the coupling structure 32, prisms 35A are huddled together without a parallel surface 35B between two adjacent prisms 35A so that the area ratio of the first slope surfaces 35C is set relatively high.

FIG. 2A illustrates arrangements of the prisms 35A for the closest and farthest regions in the prism reflection array 35 relative to the coupling structure 32. In the region therebetween, parallel surfaces may be disposed each between two adjacent prisms 35A, with narrower widths than those of the parallel surfaces 35B disposed closer to the coupling structure 32. In other words, the intervals between the prisms 35A (i.e., the array pitch) or the widths of the parallel surfaces 35B may decrease gradually or in a stepwise manner, away from the coupling structure 32 and the light receiving portion 31.

In the present embodiment, with variations in brightness taken into account, the parallel surfaces 35B are disposed in the prism reflection array 35 so that the surface density (i.e., presence ratio per unit area) of the prisms 35A increases away from the light receiving portion 31. However, such a construction is not necessarily required.

The coupling structure 32 has a light-receiving surface to receive the collimated light from the projection lens system 20. The coupling structure 32 is disposed on the outgoing surface S2 so that its light-receiving surface is inclined by an angle α_{c} with respect to the outgoing surface S1. Note that the coupling structure 32 may alternatively be disposed on an opposite surface S2 that is opposite to the outgoing surface S1 in the light guide plate 30. The opposite surface S2 corresponds to the upper principal face S2 of the light guide plate 30. In the present specification, a device having the display element 10 and the projection lens system 20 may be referred to as a “virtual image projection device 40”.

The optical axis of the virtual image projection device 40, i.e., the optical axis of the projection lens system 20, is adjusted so as to form the angle α_{c} with the normal direction of the outgoing surface S1. As a result, the optical axis of the virtual image projection device 40 is orthogonal to the light-receiving surface of the coupling structure 32.

A light beam incident through the light receiving portion 31, which is located at an end of the light guide plate 30, propagates through the interior while undergoing total reflections at the upper and lower principal faces S1 and S2 of the light guide plate 30. Specifically, a light beam undergoes total reflections at the interfaces, so long as it is incident on the upper and lower principal faces S1 and S2 of the light guide plate 30 at an incident angle not less than a critical angle as determined by the relative refractive index of the light guide plate 30 with respect to the external medium (which herein is air). Then, while repeating total reflections, the incident light beam propagates through the interior of the light guide plate 30 principally along the X direction shown in FIG. 2A.

Note that, in a region outside the region where the prism reflection array 35 is provided, the first transparent substrate 34A and the second transparent substrate 34B may directly contact each other, or alternatively, may be interconnected by an extended portion of the light-guiding layer 33 (i.e., a thin layer provided outside the region where the prism reflection array 35 is formed).

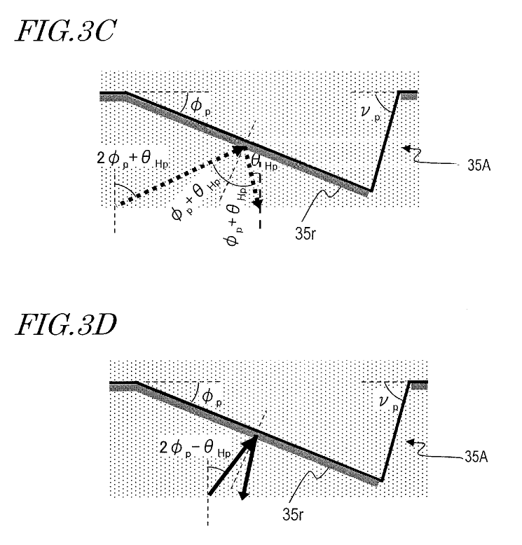

With reference to FIG. 3A to FIG. 4, and with special attention on virtual-image projection light from the center of the display element 10 of the virtual image projection device 40, the shape of a prism and the behavior of a light beam in the light guide plate 30 will be described. The virtual-image projection light is collimated light, which forms a virtual image that is viewable in the substantial front of a viewer.

FIG. 3A schematically illustrates a cross section of the light guide plate 30 in the XZ plane. FIG. 3B schematically illustrates how light is reflected off the semi-reflective film 35r in a prism 35A. FIG. 3C and FIG. 3D schematically illustrate how the light as illustrated in FIG. 2A is reflected off the semi-reflective film 35r in the prism 35A, with the horizontal angle of view (±θ_{H}) of the virtual image taken into account. The horizontal direction of the virtual image corresponds to the propagating direction of the virtual-image projection light in the light guide plate 30, i.e. the X direction. FIG. 4 schematically illustrates how the virtual-image projection light emitted from the display element 10 propagates through the interior of the light guide plate 30.

As described above, the virtual-image projection light, which has been emitted from the center of the display element 10 and collimated, is introduced via the coupling structure 32 into the light guide plate 30 to propagate through the interior of the light guide plate 30 by repeating total reflections. The light beam propagating therein, upon reflection by the semi-reflective films 35r at the prism reflection array 35 of the light guide plate 30, exits through the outgoing surface S1 of the light guide plate 30 to the exterior. The outgoing light beam will reach the viewer's pupil. On the other hand, the light beam having been transmitted through the semi-reflective films 35r propagates through the interior of the light guide plate 30 again, so as to reach the prism reflection array 35.

If the virtual-image projection light exits in a direction substantially identical to the normal direction of the outgoing surface S1 of the light guide plate 30, then the viewer can perceive, in the substantial front, a virtual image that is based on the virtual-image projection light from the center of the display element 10. To this end, the relationship of eq. (1) needs to be satisfied between the incident angle (and reflection angle 2φₛ of the virtual-image projection light with respect to the outgoing surface S1 of the light guide plate 30, and the slope angle φₚ of the first slope surfaces 35C, where nₛ denotes the refractive index of the transparent substrates, and nₚ denotes the refractive index of the light-guiding layer 33:

1≤nₛ·sin(2φₛ)=nₚ·sin(2φₚ). eq. (1)

Furthermore, with the horizontal angle of view (±θ_{H}) of the virtual image taken into account, there is also virtual-image projection light being incident on the light-guiding layer 33 of the light guide plate 30 at an angle of 2φₚ±θ_{Hp} with respect to the normal direction of the outgoing surface S3 of the light-guiding layer 33. Regarding this, eq. (2) holds true. The angle θ_{Hp} is an angle which is in accordance with the angle of view θ_{H}, denoting the incident angle of a light beam reflected off the semi-reflective film 35r with respect to the normal direction of the outgoing surface S3 of the light-guiding layer 33. In the present embodiment, the slope angle φₚ of the first slope surfaces 35C is chosen to be 26°, while the horizontal angle of view θ_{H} is chosen to be 10°. Note that the semi-reflective films 35r are formed through oblique vapor deposition or the like, as will be described later. In this respect, the slope angle νₚ of the second slope surfaces 35D is preferably an angle which is near 90° so as to avoid unwanted deposition of stray vapor in oblique vapor deposition. In the present embodiment, the slope angle νp is chosen to be 85°:

sin(θ_{H})=nₚ·sin(θ_{Hp}) and 1≤nₚ·sin(2φₚ−θ_{H}). eq. (2)

As illustrated in FIG. 4, the virtual-image projection light from the center of the display element 10 propagates through the interior while undergoing total reflections at the incident angle 2φₛ off the upper and lower principal faces S1 and S2 of the light guide plate 30, and is reflected off the semi-reflective films of the prism reflection array 35 so as to reach the viewer. In order to allow the virtual-image projection light to exit in a direction substantially identical to the normal direction of the outgoing surface S1 of the light guide plate 30 so that the viewer can perceive the virtual image in the substantial front, the relationship of eq. (3) needs to hold true, where n_{c} denotes the refractive index of the coupling structure 32, and the angle 2φ_{c} is the incident angle of the virtual-image projection light on the interface (i.e., the lower principal face S1) between the coupling structure 32 and the light guide plate 30:

1≤n_{c}·sin(2φ_{c})=nₛ·sin(2φₛ)=nₚ·sin(2φₚ). eq. (3)

As in the present embodiment, when the optical axis of the virtual image projection device 40 is disposed so as to be perpendicular to the light-receiving surface of the coupling structure 32, the angle 2φ_{c} becomes equal to the slope angle α_{c} of the light-receiving surface of the coupling structure 32. As a result, eq. (3) may be transformed into eq. (4) using the slope angle α_{c}:

1≤n_{c}·sin(α_{c})=nₛ·sin(2φs)=nₚ·sin(2φₚ). eq. (4)

In the present embodiment, where the slope angle φₚ of the first slope surfaces 35C is set at 26°, if the refractive index n_{c} of the coupling structure 32 were equal to the refractive index nₚ of the light-guiding layer 33, then the slope angle α₀ would become equal to the angle 2φₚ; as a result, the slope angle α_{c} would become 52°. As mentioned earlier, this relationship between the refractive indices is disclosed in e.g. Patent Document 1.

On the other hand, according to eq. (4), making the refractive index n_{c} of the coupling structure 32 greater than the refractive index nₚ of the light-guiding layer 33 will allow the slope angle α_{c} to be decreased. In other words, the relationship α_{c}<2φₚ will be satisfied. In order that this relationship between the refractive indices is satisfied, in the present embodiment, the refractive index n_{c} of the coupling structure 32 is chosen to be 1.70, while the refractive index nₚ of the light-guiding layer 33 is chosen to be 1.51. This condition allows to set the slope angle α_{c} to be 44.6°, which is smaller than the conventional angle (i.e., 52°).

Next, a method of producing a virtual image display apparatus 100 will be described.

As illustrated in FIG. 2A and the like, a virtual image display apparatus 100 includes a display element 10, a projection lens system 20, and a light guide plate 30, and is produced by appropriately disposing these. As mentioned earlier, the display element 10 and the projection lens system 20 can be of various implementations. On the other hand, the display element 10, the projection lens system 20, and the light guide plate 30 may be appropriately disposed for the application through known methods, which will not be described in detail here. Hereinafter, a method of producing a lightguide which has a light guide plate 30 including a prism reflection array 35 and which has a coupling structure 32 will mainly be described.

A prism surface having a prism reflection array 35 can be produced through e.g. injection molding, compression molding, and the 2p process (Photo Polymerization Process). For example, a semi-reflective film 35r is formed by vapor-depositing a metal film, a dielectric film, or the like to a predetermined film thickness on a first slope surface 35C of a molded prism 35A. Thereafter, as a second light-guiding layer 33B, which is a planarization member, a photocurable (typically, ultraviolet-curable) resin, a thermosetting resin, a two-component epoxy resin, or the like is applied on the prism surface, thereby forming a light-guiding layer 33. By using a second transparent substrate 34B for pressurized filling of the second light-guiding layer 33B in between a first transparent substrate 34A and the second transparent substrate 34B, the resin of the second light-guiding layer 33B is cured by polymerization. Through the above steps, a prism reflection array 35 and a light guide plate 30 are completed.

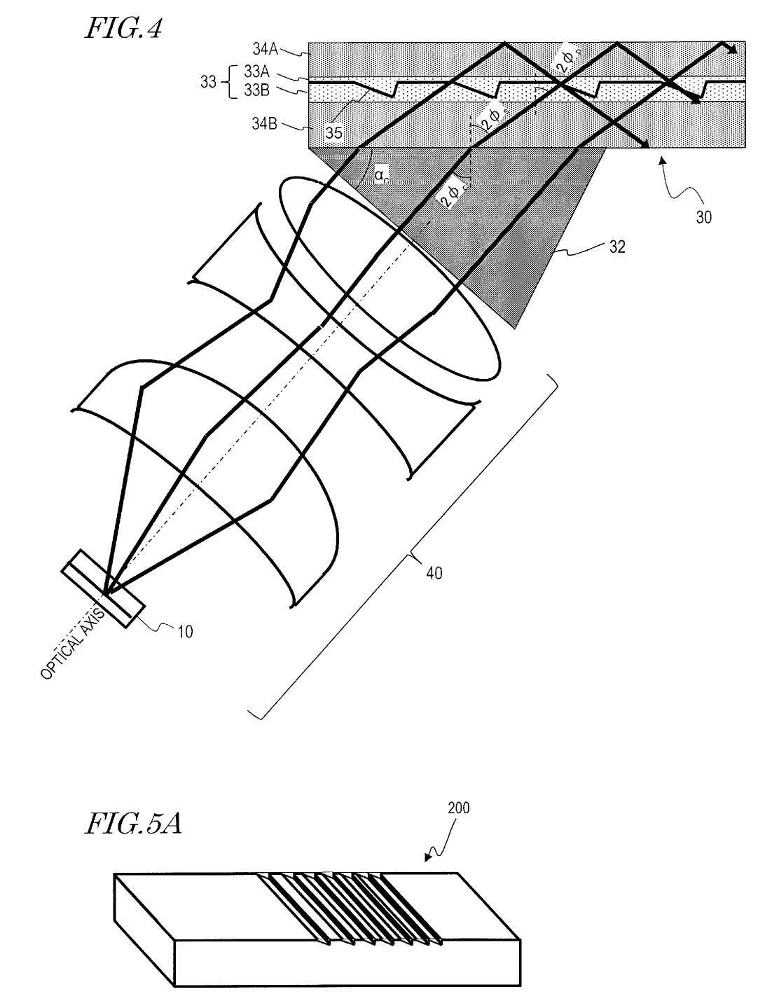

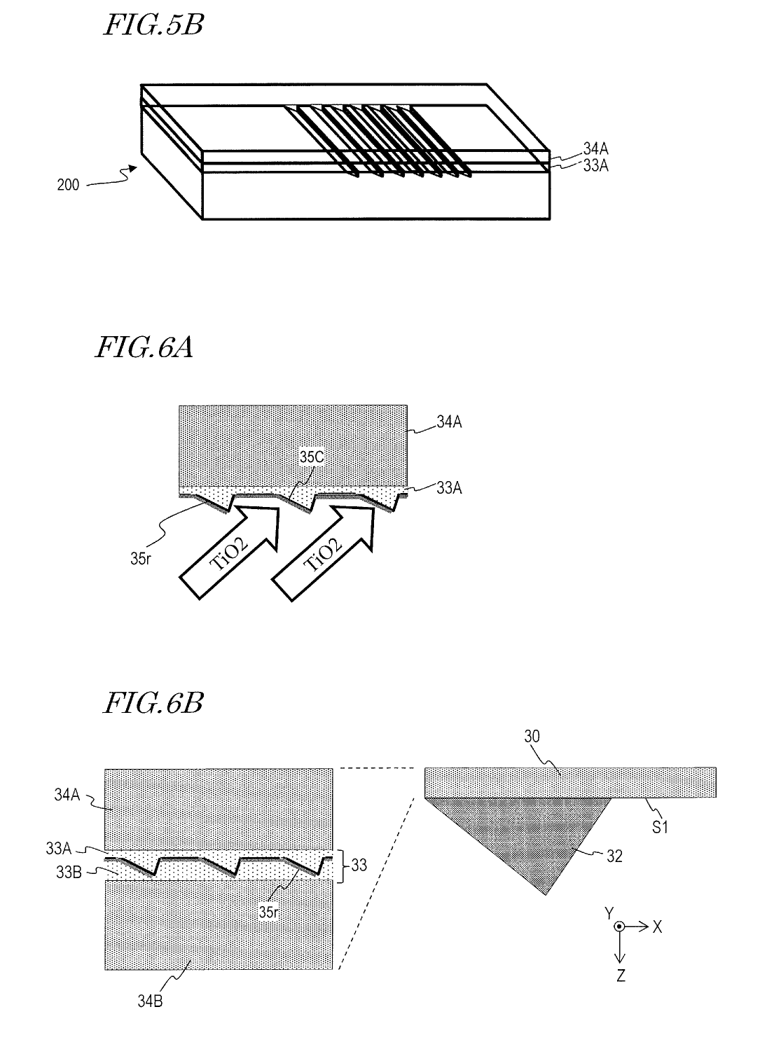

With reference to FIG. 5 to FIG. 6B, a method of producing a prism reflection array 35 and a light guide plate 30 will be described in detail.

FIG. 5A schematically illustrates the appearance of a die 200 to be used for producing a prism reflection array 35. FIG. 5B illustrates how the shape of the die 200 may be transferred to a transparent molding member (first light-guiding layer 33A) on a first transparent substrate 34A. FIG. 6A schematically illustrates how semi-reflective films 35r may be formed on the prism reflection array 35 through oblique vapor deposition. FIG. 6B schematically illustrates a cross section, as taken parallel to the XZ plane, of a light guide plate 30 which is obtained by attaching the first transparent substrate 34A and a second transparent substrate 34B to each other.

First, a first transparent substrate 34A is provided. As the first transparent substrate 34A, a glass substrate “B270” (refractive index=1.52) manufactured by SCHOTT was used. This glass substrate has a refractive index nₛ of 1.52. A plate of other transparent resins may also be used as the first transparent substrate 34A. The first transparent substrate 34A has a thickness of 1.0 mm, for example.

In the present embodiment, a first light-guiding layer 33A having a lens surface is formed on the first transparent substrate 34A by using the 2p process. Specifically, as illustrated in FIG. 5B, a UV-curable resin is applied on a die 200 which has a transcription pattern formed on its surface. The die 200 has convex structures correspondingly to the concaved prism surface. Thereafter, the first transparent substrate 34A is placed onto the UV-curable resin from above and press-fitted. Then, after the resin is cured with ultraviolet irradiation through the first transparent substrate 34A, a mold releasing process is performed. Thus, the first transparent substrate 34A, which includes the first light-guiding layer 33A having transferred thereon a transcription pattern, is obtained. On the surface of the first light-guiding layer 33A, a prism surface is formed.

As the transparent material of the first light-guiding layer 33A, a UV-curable resin “LU1303HA” (refractive index=1.51) manufactured by DAICEL was used. The first light-guiding layer 33A has a refractive index nₚ of 1.51. The material of the first light-guiding layer 33A is typically a UV-curable resin; however, it may be other UV-curable resins, thermosetting resins, two-component epoxy resins, etc.

As illustrated in FIG. 6A, through oblique vapor deposition of a dielectric, semi-reflective films 35r are formed selectively on the first slope surfaces 35C in the prism surface, which are inclined at a slope angle φₚ with respect to the outgoing surface S1. As the material for vapor deposition of the semi-reflective films 35r, TiO₂ can be used, for example. In the present embodiment, the thickness of the semi-reflective films 35r was chosen to be about 65 nm. Note that, as the material of the semi-reflective films 35r, other dielectrics and metal materials (e.g., Al or Ag) also are available.

As illustrated in FIG. 6B, by using a second light-guiding layer 33B made of the same material as the first light-guiding layer 33A, the prism surface of the first light-guiding layer 33A is planarized. The refractive index of the second light-guiding layer 33B is equal to that of the first light-guiding layer 33A. As a planarization member, a photocurable (typically, ultraviolet-curable) resin is interposed between the second transparent substrate 33B and the prism surface of the first light-guiding layer 33A, which resin is cured by polymerization following pressurized filling. As in the first light-guiding layer 33A, the material of the second light-guiding layer 33B may be other UV-curable resins, thermosetting resins, two-component epoxy resins, etc. As the second transparent substrate 33B, a glass substrate “B270” manufactured by SCHOTT was used, which is the same as the first transparent substrate 33A. The thickness of the second transparent substrate 34B is equal to that of the first transparent substrate 34A: 1.0 mm, for example.

As described earlier, in the present embodiment, the refractive index nₚ of the light-guiding layer 33 (the first light-guiding layer 33A and the second light-guiding layer 33B) is substantially equal to the refractive index nₛ of the transparent substrates.

For a coupling structure 32, a glass material “S-LAL14” (refractive index=1.70) manufactured by OHARA INC. was used. The coupling structure 32 has a refractive index n_{c} of 1.70. The coupling structure 32 and the light guide plate 30 are made of distinct materials, where the refractive index n_{c} of the coupling structure 32 is greater than that of the light guide plate 30. The refractive index of the light guide plate 30 principally means the refractive index nₚ of the light-guiding layer 33.

As illustrated in FIG. 6B, the coupling structure 32 is disposed on the outgoing surface S1 of the light guide plate 30 and secured with an adhesive; thereby, a lightguide having the coupling structure 32 and having the light guide plate 30 can be produced.

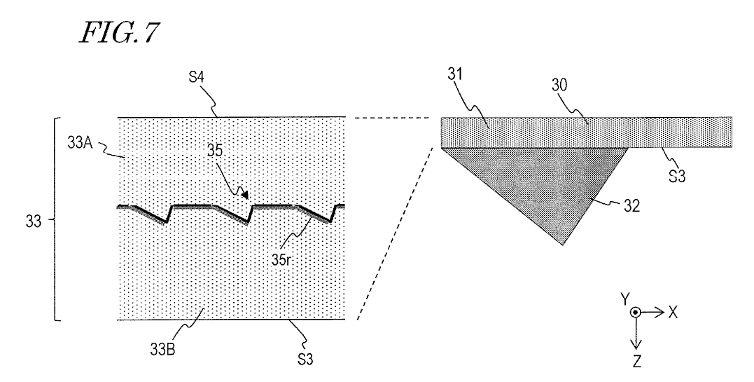

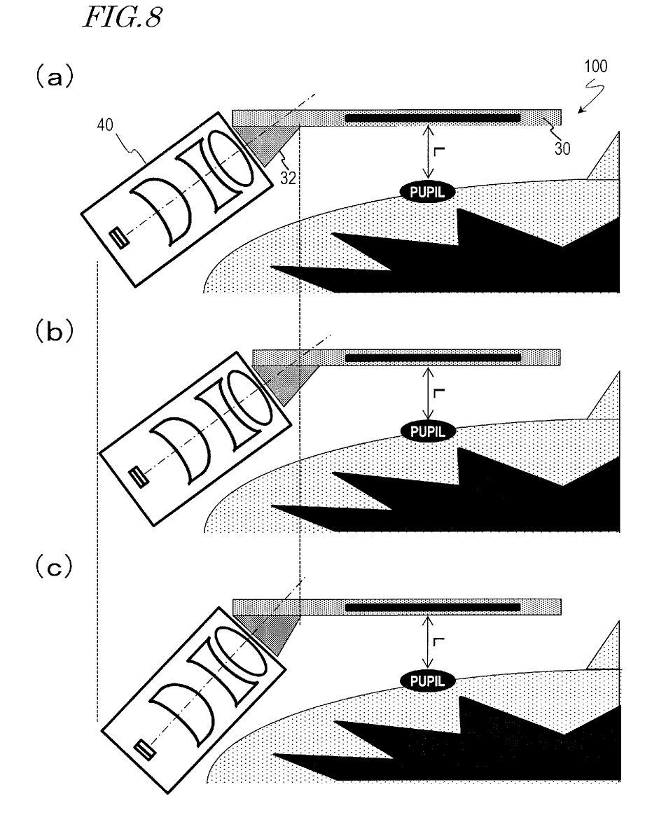

One advantage is that sandwiching the light-guiding layer 33 between the transparent substrates allows to enhance the strength and durability of the light guide plate 30. Another advantage is that using the transparent substrates allows to easily produce the light guide plate 30. However, if durability can be achieved with the light-guiding layer 33 alone, for example, the first transparent substrate 34A and/or the second transparent substrate 34B may possibly be omitted from the light guide 30. Accordingly, with reference to FIG. 7, a variant of the light guide plate 30 of the present embodiment will be described.

FIG. 7 schematically illustrates, in a variant of the light guide plate 30, a cross section of the light guide plate 30 being taken parallel to the XZ plane, at an end having a light receiving portion 31. The light guide plate 30 according to the present variant doesn't have any transparent substrates to sandwich a light-guiding layer 33. In other words, the light guide plate 30 is composed of a light-guiding layer 33 having a first light-guiding layer 33A and having a second light-guiding layer 33B. In such a structure, a light beam that is incident through the light receiving portion 31, which is located at the end of the light guide plate 30 and hence the light-guiding layer 33, propagates through the interior while undergoing total reflections at upper and lower principal faces S3 and S4 of the light guide plate 30. Specifically, a light beam undergoes total reflections at the interfaces, so long as it is incident on the upper and lower principal faces S3 and S4 of the light guide plate 30 at an incident angle not less than a critical angle as determined by the relative refractive index of the light guide plate 30 with respect to the external medium (which herein is air). Then, while repeating total reflections, the incident light beam propagates through the interior of the light guide plate 30 principally along the X direction shown in FIG. 7.

The light beam propagating through the interior is reflected off semi-reflective films 35r at a prism reflection array 35 of the light guide plate 30, so as to go out to the exterior through an outgoing surface S3 of the light guide plate 30. Note that implementations in which the light guide plate 30 lacks either one of the first transparent substrate 34A and the second transparent substrate 34B also fall within the scope of the present invention, although not shown in the drawings.

FIGS. 8(a) and (b) each schematically illustrate a relative positioning between a viewer and the virtual image projection device 40 as seen from above the viewer's head, where the viewer wears a virtual image display apparatus 100 having a light guide plate 30 in which the refractive index n_{c} of the coupling structure 32 and the refractive index nₚ of the light-guiding layer 33 coincide with each other. FIG. 8(c) schematically illustrates a relative positioning between the viewer and the virtual image projection device 40 as seen from above the viewer's head, where the viewer wears a virtual image display apparatus 100 having a light guide plate 30 in which the refractive index n_{c} of the coupling structure 32 is greater than the refractive index nₚ of the light-guiding layer 33. Note that, in a state where the virtual image display apparatus 100 is worn by the viewer, the distance L between the light guide plate 30 and the viewer's pupil is invariable. In a state where common spectacles are worn, the distance between one of the glasses and the pupil is considered to be about 12 mm to 15 mm.

As illustrated in FIG. 8(a), if the refractive index n_{c} of the coupling structure 32 and the refractive index nₚ of the light-guiding layer 33 coincided with each other, setting the slope angle φ of the first slope surfaces 35C at 26° might cause the slope angle α_{c} of the light-receiving surface of the coupling structure 32 to be set at 52°; in that case, trying to expand the peripheral field of view would end up causing the virtual image projection device 40 to protrude outside the virtual image display apparatus 100 being shaped like spectacles. The aesthetics of such a virtual image display apparatus 100 cannot be considered too good.

As illustrated in in FIG. 8(b), trying in favor of aesthetics to prevent the virtual image projection device 40 from protruding outside would require the coupling structure 32 and the virtual image projection device 40 to be closer to the position of the viewer's pupil. As a result, they would end up partially blocking the field of view so as to narrow the field of view regarding the periphery.

As illustrated in FIG. 8(c), when the refractive index n_{c} of the coupling structure 32 is greater than the refractive index nₚ of the light-guiding layer 33, setting the slope angle φ of the first slope surfaces 35C at 26° allows the slope angle αₑ of the light-receiving surface of the coupling structure 32 to be set at e.g. 44.6° (which is smaller than 52°) as described earlier. In this case, even with the peripheral field of view kept wide, outward protrusion of the virtual image projection device 40 can be prevented; thus, there is provided a virtual image display apparatus 100 which conserves a viewer's field of view without detracting from aesthetics.

### Second Embodiment

The structure of a virtual image display apparatus 100 according to a second embodiment is identical to that of the virtual image display apparatus 100 according to the first embodiment. Therefore, a detailed description of the structure of the virtual image display apparatus 100 will be omitted.

FIG. 9 schematically illustrates a state in which a virtual image display apparatus 100 is worn by a viewer so that the light guide plate 30 is inclined at an angle θ₀ with respect to the viewer. In the present embodiment, the virtual image display apparatus 100 is worn by the viewer in such a manner that the light guide plate 30 is inclined at the angle θ₀ with respect to the viewer. The angle θ₀ is an angle which the normal of the outgoing surface S1 of the light guide plate 30 forms with the Z direction shown in FIG. 9.

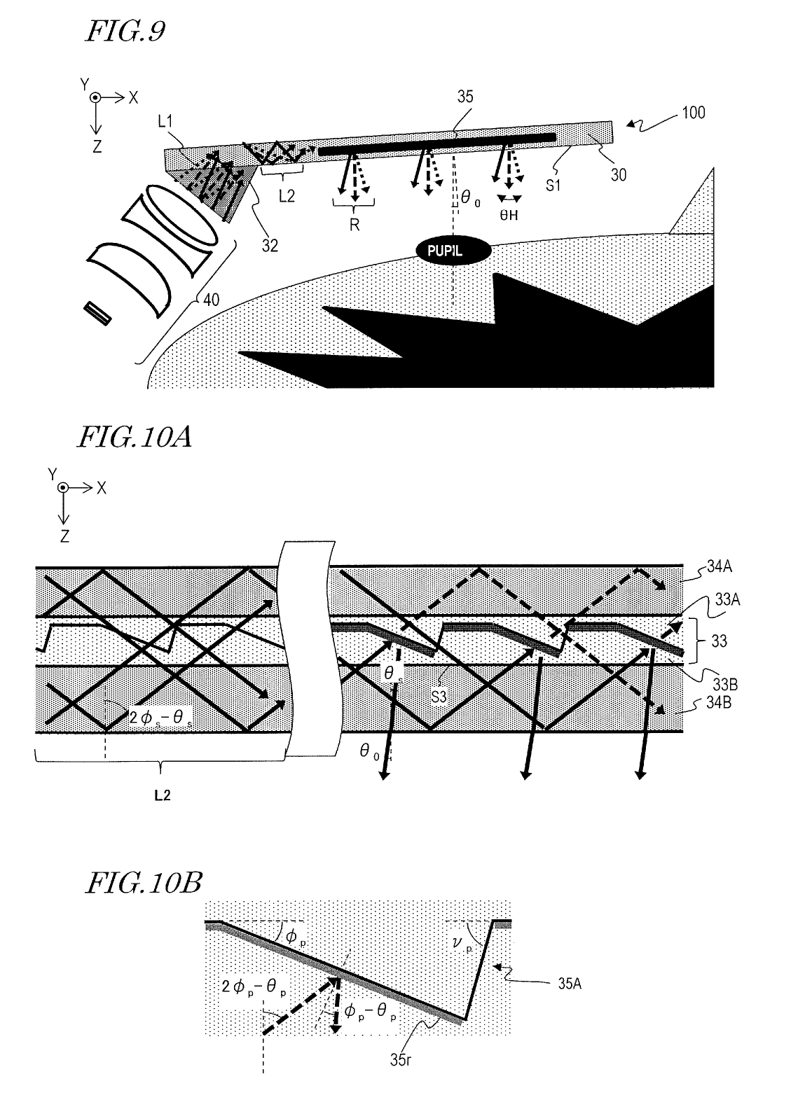

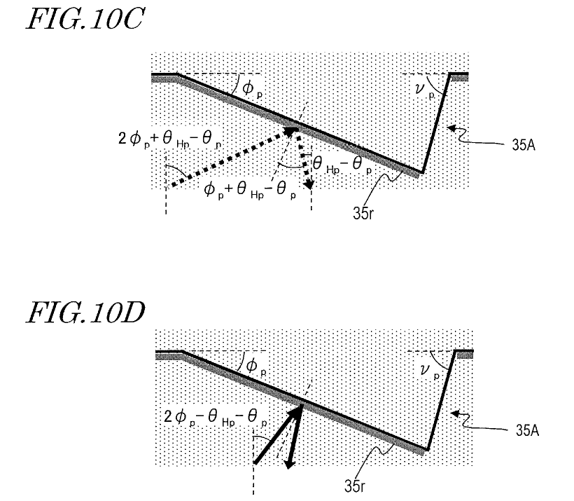

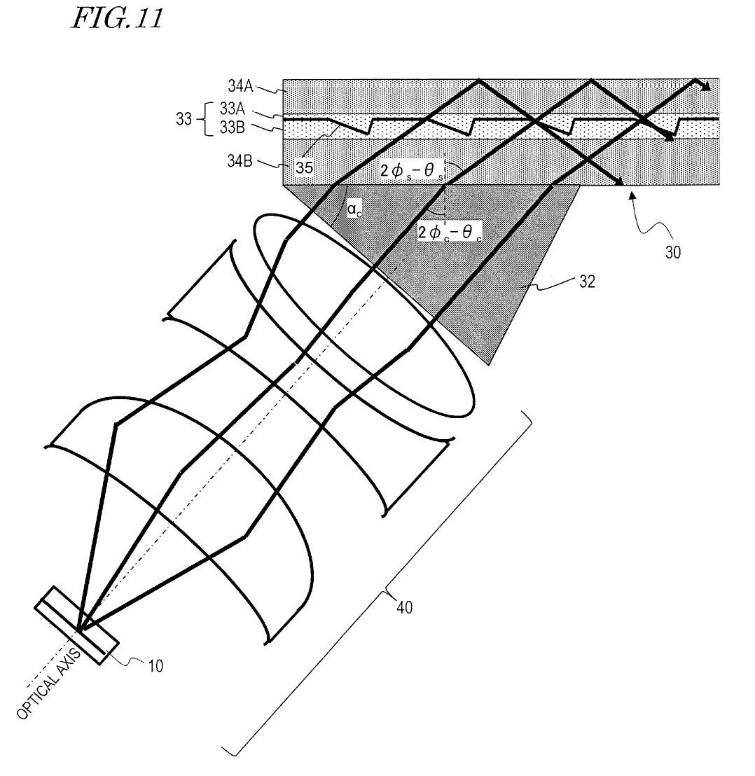

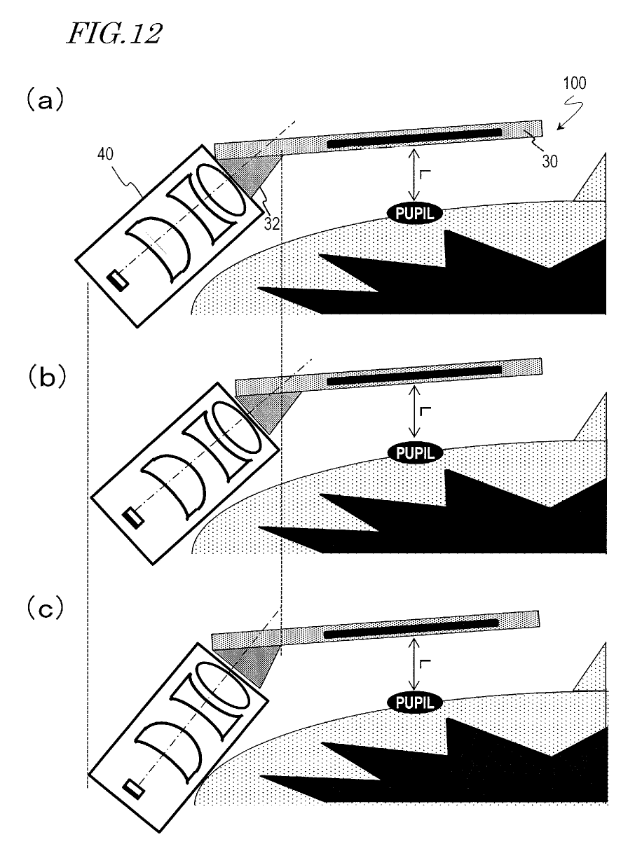

With reference to FIG. 10A to FIG. 11, and with special attention on virtual-image projection light from the center of the display element 10 of the virtual image projection device 40, behavior of a light beam in the light guide plate 30 will be described.

FIG. 10A schematically illustrates a cross section of the light guide plate 30 in the XZ plane. FIG. 10B schematically illustrates how the light is reflected off a semi-reflective film 35r in a prism 35A. FIG. 10C and FIG. 10D schematically illustrates how the light is reflected off the semi-reflective film 35r in the prism 35A, with the horizontal angle of view (±θ_{H}) of the virtual image taken into account. FIG. 11 schematically illustrates how the virtual-image projection light emitted from the display element 10 propagates through the interior of the light guide plate 30.

As in the first embodiment, the virtual-image projection light, which has been emitted from the center of the display element 10 and collimated, is introduced via the coupling structure 32 into the light guide plate 30 to propagate through the interior of the light guide plate 30 by repeating total reflections. The light beam propagating therein, upon reflection by the semi-reflective films 35r at the prism reflection array 35 of the light guide plate 30, exits through the outgoing surface S1 of the light guide plate 30 to the exterior. The outgoing light beam will reach the viewer's pupil. On the other hand, the light beam having been transmitted through the semi-reflective films 35r propagates through the interior of the light guide plate 30 again, so as to reach the prism reflection array 35.

If the virtual-image projection light exits at an angle θ₀ with respect to the normal direction of the outgoing surface S1 of the light guide plate 30, then the viewer can perceive, in the substantial front, a virtual image that is based on the virtual-image projection light from the center of the display element 10. To this end, the relationship of eq. (5) needs to be satisfied between the incident angle (and reflection angle) 2(φₛ−θₛ) of the virtual-image projection light with respect to the outgoing surface S1 of the light guide plate 30, and the slope angle φₚ of the first slope surfaces 35C, where the angle θₛ denotes an incident angle at which the light beam having reflected off the semi-reflective films 35r should strike the outgoing surface S1 in order to exit at the angle θ₀ with respect to the normal direction of the outgoing surface S1 of the light guide plate 30; similarly, the angle θp denotes an incident angle at which the light beam having reflected off the semi-reflective films 35r should strike the outgoing surface S3 of the light-guiding layer 33 in order to exit from the outgoing surface S1 of the light guide plate 30 at the angle θ₀ with respect to the normal direction thereof; nₛ denotes the refractive index of the transparent substrates, and nₚ denotes the refractive index of the light-guiding layer 33:

1≤nₛ·sin(2φₛ−θₛ)=nₚ·sin(2φₚ−θₚ)

and

sin(θ₀)=nₛ·sin(θₛ)=nₚ·sin(θₚ). eq. (5)

Furthermore, with the horizontal angle of view (±θ_{H}) of the virtual image taken into account, there is also virtual-image projection light being incident on the light-guiding layer 33 of the light guide plate 30 at an angle of (2φₚ±θ_{Hp}−θₚ) with respect to the normal direction of the outgoing surface S3 of the light-guiding layer 33. Regarding this, eq. (6) holds true. The angle θ_{Hp}−θₚ is an angle which is in accordance with the angle of view θ_{H}, denoting the incident angle of a light beam reflected off the semi-reflective film 35r with respect to the normal direction of the outgoing surface S3 of the light-guiding layer 33. In the present embodiment, the slope angle φₚ of the first slope surfaces 35C is chosen to be 26°, the angle θ₀ is chosen to be 5°, and the horizontal angle of view θ_{H} is chosen to be 10°. Note that, as in the first embodiment, the slope angle νₚ of the second slope surfaces 35D is preferably an angle which is near 90° so as to avoid unwanted deposition of stray vapor in oblique vapor deposition. In the present embodiment, the slope angle νₚ is chosen to be 85°:

sin(θ_{H}−θ₀)=nₚ·sin(θ_{Hp}−θₚ),

sin(θ_{H}+θ₀)=nₚ·sin(θ_{Hp}+θₚ),

and

1≤nₚ·sin(2φₚ−θ_{Hp}−θₚ). eq. (6)

As illustrated in FIG. 11, the virtual-image projection light from the center of the display element 10 propagates through the interior while undergoing total reflections at the incident angle 2φₛ−θₑ off the upper and lower principal faces S1 and S2 of the light guide plate 30, and is reflected off the semi-reflective films of the prism reflection array 35 so as to reach the viewer. In order to allow the virtual-image projection light to exit at the angle θ₀ with respect to the normal direction of the outgoing surface S1 of the light guide plate 30 so that the viewer can perceive the virtual image in the substantial front, the relationship of eq. (7) needs to hold true, where n_{c} denotes the refractive index of the coupling structure 32, and the angle 2φ_{c}−θ_{c} is the incident angle of the virtual-image projection light on the interface (i.e., the lower principal face S1) between the coupling structure 32 and the light guide plate 30:

1≤n_{c}·sin(2φ_{c}−θ_{c})=nₛ·sin(2φₛs−θₛ)=nₚ·sin(2φₚ−θₚ). eq. (7)

As in the present embodiment, when the optical axis of the virtual image projection device 40 is disposed so as to be perpendicular to the light-receiving surface of the coupling structure 32, the angle 2φ_{c}−θ_{c} becomes equal to the slope angle α_{c} of the light-receiving surface of the coupling structure 32. As a result, eq. (7) may be transformed into eq. (8) using the slope angle α_{c}:

1≤n_{c}·sin(α_{c})=nₛ·sin(2φₛ−θₛ)=nₚ·sin(2φₚ−θₚ). eq. (8)

In the present embodiment, where the slope angle φₚ of the first slope surfaces 35C is set at 26°, if the refractive index n_{c} of the coupling structure 32 were equal to the refractive index nₚ of the light-guiding layer 33, then the slope angle α_{c} would become equal to the angle 2φₚ−θₚ; as a result, the slope angle α_{c} would become 48.7.

On the other hand, according to eq. (8), making the refractive index n_{c} of the coupling structure 32 greater than the refractive index nₚ of the light-guiding layer 33 will allow the slope angle α_{c} to be decreased. In other words, the relationship α_{c}<2φₚ−θₚ will be satisfied. In order that this relationship between the refractive indices is satisfied, in the present embodiment, the refractive index n_{c} of the coupling structure 32 is chosen to be 1.70, while the refractive index nₚ of the light-guiding layer 33 is chosen to be 1.51, as in the first embodiment. Thus, the slope angle α_{c} can be set at 41.9°, which is smaller than the conventional angle (i.e., 52°) and even smaller than the slope angle 44.6° being achieved in the first embodiment.

FIGS. 12(a) and (b) each schematically illustrate a relative positioning between a viewer and the virtual image projection device 40 as seen from above the viewer's head, where the viewer wears a virtual image display apparatus 100 having a light guide plate 30 in which the refractive index n_{c} of the coupling structure 32 and the refractive index nₚ of the light-guiding layer 33 coincide with each other. FIG. 12(c) schematically illustrates a relative positioning between the viewer and the virtual image projection device 40 as seen from above the viewer's head, where the viewer wears a virtual image display apparatus 100 having a light guide plate 30 in which the refractive index n_{c} of the coupling structure 32 is greater than the refractive index nₚ of the light-guiding layer 33.

As illustrated in FIG. 12(a), if the refractive index n_{c} of the coupling structure 32 and the refractive index nₚ of the light-guiding layer 33 coincided with each other, setting the slope angle φ of the first slope surfaces 35C at 26° might cause the slope angle α_{c} of the light-receiving surface of the coupling structure 32 to be set at 48.7°; in that case, trying to expand the peripheral field of view would end up causing the virtual image projection device 40 to protrude outside the virtual image display apparatus 100 being shaped like spectacles. The aesthetics of such a virtual image display apparatus 100 cannot be considered too good.

As illustrated in FIG. 12(b), trying in favor of aesthetics to prevent the virtual image projection device 40 from protruding outside would require the coupling structure 32 and the virtual image projection device 40 to be closer to the position of the viewer's pupil. As a result, they would end up partially blocking the field of view so as to narrow the field of view regarding the periphery.

As illustrated in FIG. 12(c), when the refractive index n_{c} of the coupling structure 32 is greater than the refractive index nₚ of the light-guiding layer 33, setting the slope angle φ of the first slope surfaces 35C at 260 allows the slope angle α_{c} of the light-receiving surface of the coupling structure 32 to be set at e.g. 41.9° (which is even smaller than the slope angle 44.6° being achieved in the first embodiment) as described earlier. In this case, even with the peripheral field of view kept wide, outward protrusion of the virtual image projection device 40 can be prevented; thus, there is provided a virtual image display apparatus 100 which conserves a viewer's field of view without detracting from aesthetics.

According to the present embodiment, a virtual image projection device 40 can be disposed so as to fit even more closely along a viewer's side face than according to the first embodiment.

### Third Embodiment

A virtual image display apparatus 100A according to a third embodiment differs from the virtual image display apparatus 100 according to the first embodiment in that it further includes an image processing circuit 50. Hereinafter, any description of commonalties with the virtual image display apparatus 100 according to the first embodiment will be omitted, so that differences are mainly described.

In the virtual image display apparatuses 100 according to the first and second embodiments, owing to the structure thereof, what is to be perceived as a virtual image by a viewer will be an image which is based on the image input to the virtual image projection device 40 but has undergone expansion along the X direction (the direction along which the prism reflection array 35 is arranged) in FIG. 13. This derives from the difference between the refractive index n_{c} (=1.70) of the coupling structure 32 and the refractive index nₚ (=1.51) of the light-guiding layer 33.

FIG. 13 schematically illustrates the construction of a virtual image display apparatus 100A according to the third embodiment. The virtual image display apparatus 100A further includes an image processing circuit 50 with which to correct expansion of an image.

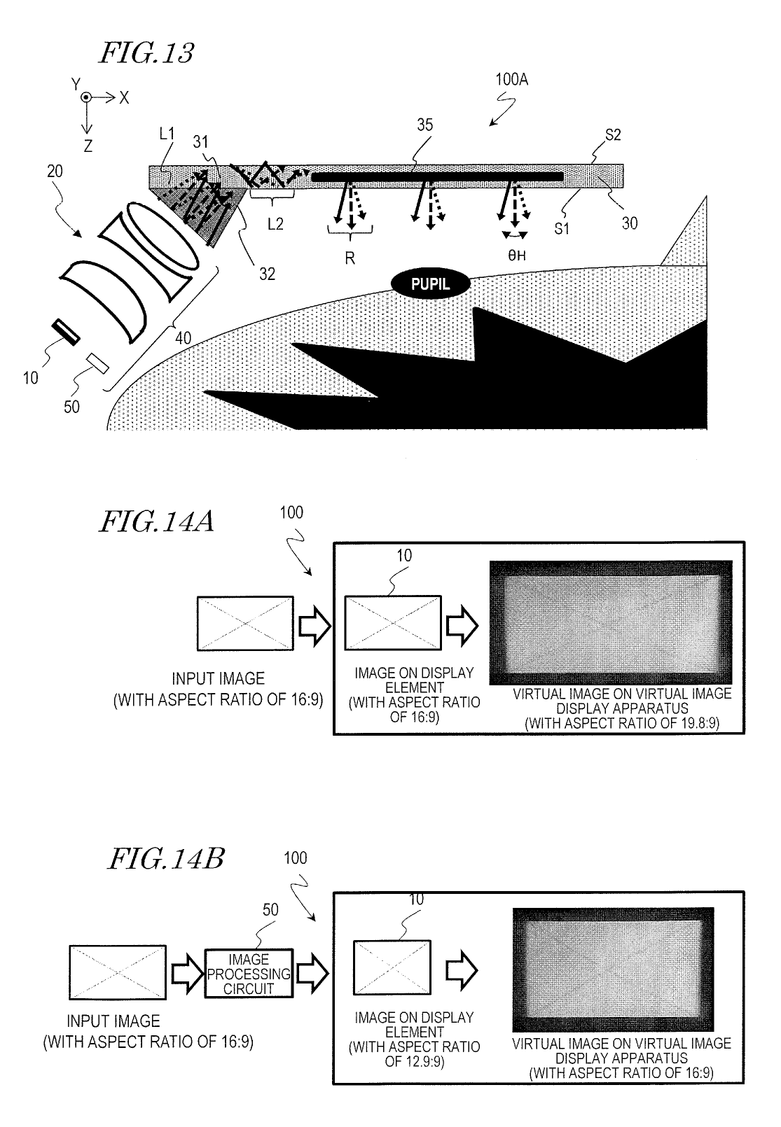

FIG. 14A schematically illustrates a virtual-image pattern displayed without input image correction. FIG. 14B schematically illustrates a virtual-image pattern displayed with input image correction.

As illustrated in FIG. 14A, given an input image having an aspect ratio of 16:9, the display element 10 displays an image which has the same aspect ratio (16:9) as does the input image; consequently, the displayed image (virtual image) on the virtual image display apparatus 100 becomes an image having undergone horizontal expansion of the input image, so as to have an aspect ratio of 19.8:9, for example.

On the other hand, as illustrated in FIG. 14B, the image processing circuit 50 reduces the input image horizontally in accordance with the rate of expansion. In the example of the drawing, the image processing circuit 50 converts the input image having an aspect ratio of 16:9 into a reduced image having an aspect ratio of 12.9:9, which is output to the display element 10. The display element 10 will display the reduced image. As a result, the displayed image (virtual image) on the virtual image display apparatus 100 will have the same aspect ratio of 16:9 as does the input image. Thus, the original aspect ratio of the input image can be reproduced in the virtual image to be viewed on the virtual image display apparatus 100.

### Fourth Embodiment

A virtual image display apparatus 100B according to a fourth embodiment differs from the virtual image display apparatus 100 according to the first embodiment in that the coupling structure 32 contacts an end face of the light guide plate 30 which is substantially orthogonal to the propagating direction of a light beam propagating through the interior of the light guide plate 30. Hereinafter, any description of commonalties with the virtual image display apparatus 100 according to the first embodiment will be omitted, so that differences are mainly described.

FIG. 15 schematically illustrates the structure of a virtual image display apparatus 100B according to the present embodiment.

The structure of a light guide plate 30 according to the present embodiment is identical to that of the light guide plate 30 according to the first embodiment. Therefore, a light guide plate 30 according to the present embodiment can be produced by using the method of production as described in the first embodiment, for example. Note that the refractive indices of the transparent substrates and the coupling structure 32 are different from the refractive indices of those members according to the first embodiment.

In the present embodiment, glass substrates of “SFL6” (refractive index=1.81) manufactured by SCHOTT were used as the transparent substrates. The refractive index nₛ of the transparent substrates is 1.81. Plates of other transparent resins may also be used as the transparent substrates. The thicknesses of the transparent substrates are 1.0 mm, for example. On the other hand, the coupling structure 32 was produced by using glass material “S-TIL6” (refractive index=1.53) manufactured by OHARA INC. The refractive index n_{c} of the coupling structure 32 is 1.53. Note that the refractive index nₚ of the light-guiding layer 33 is 1.51, as in the first embodiment.

The coupling structure 32 and the light guide plate 30 are made of distinct materials, where the refractive index n_{c} of the coupling structure 32 is smaller than that of the light guide plate 30. Specifically, the refractive index n_{c} of the coupling structure 32 needs only to be smaller than the refractive index of either the light-guiding layer 33 or the transparent substrates; furthermore, it is preferably smaller than the refractive index of whichever one of the light-guiding layer 33 and the transparent substrates that is predominant with respect to the thickness of the light guide plate. In the present embodiment, the refractive index n_{c} of the coupling structure 32 is smaller than the refractive index nₛ of the transparent substrates.

The coupling structure 32, unlike in the first embodiment, contacts an end face S5 of the light guide plate 30 which is substantially orthogonal to the propagating direction (the X direction shown in FIG. 15) of a light beam propagating through the interior of the light guide plate 30. The light-receiving surface of the coupling structure 32 is inclined at a slope angle α_{c} with respect to the upper principal face S2 (or the lower principal face S1) of the light guide plate.

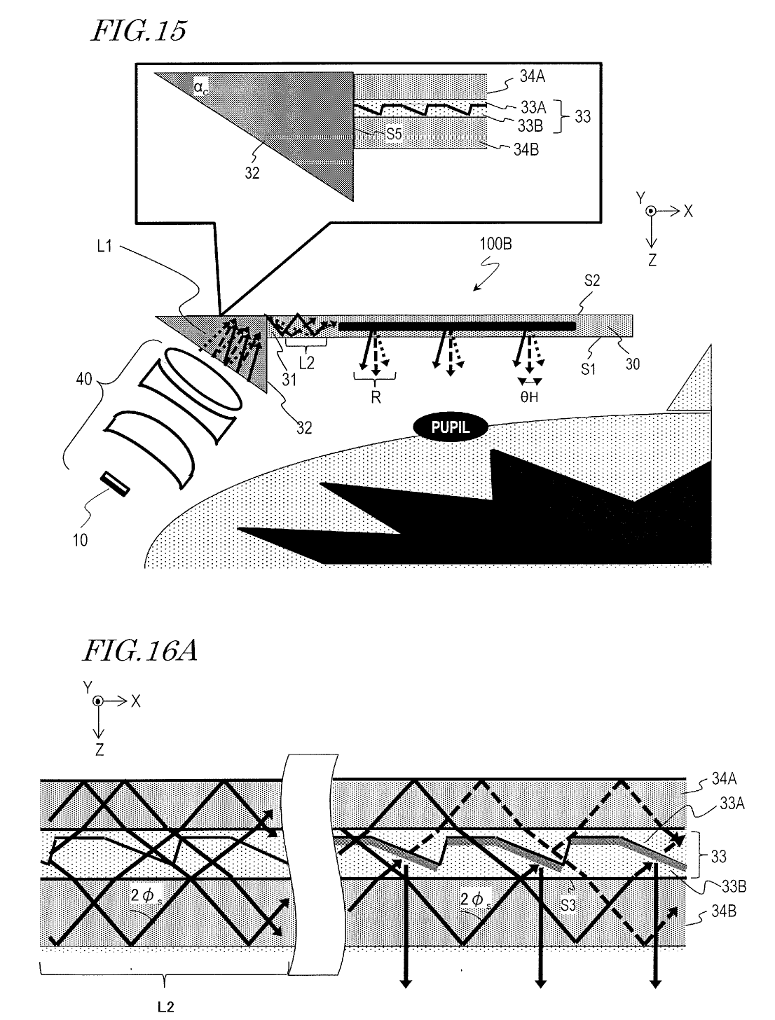

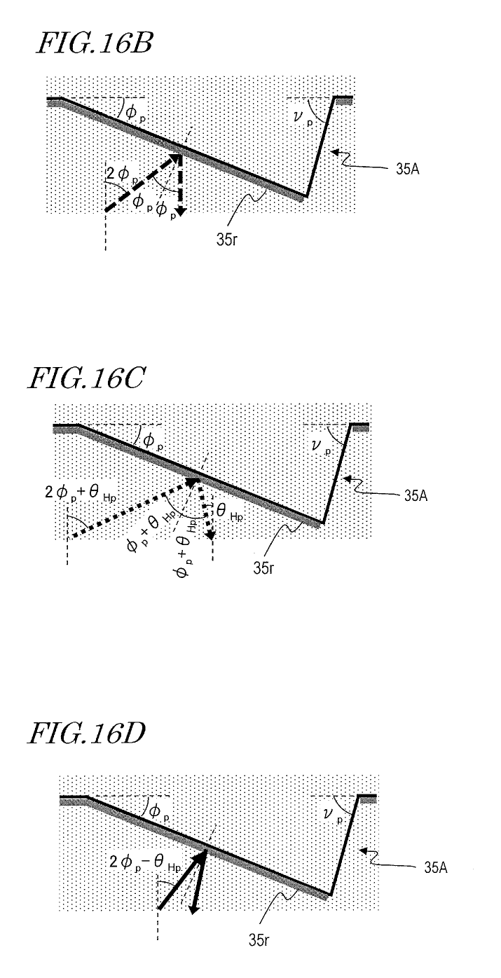

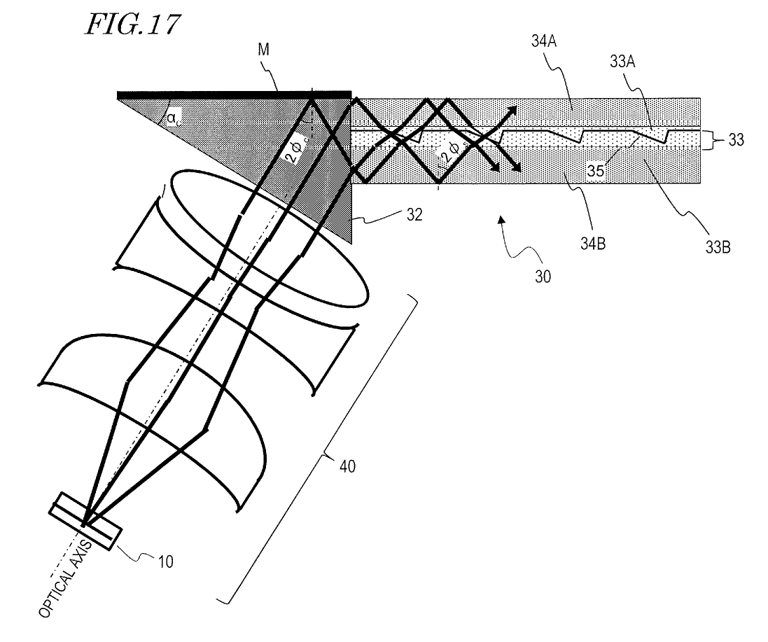

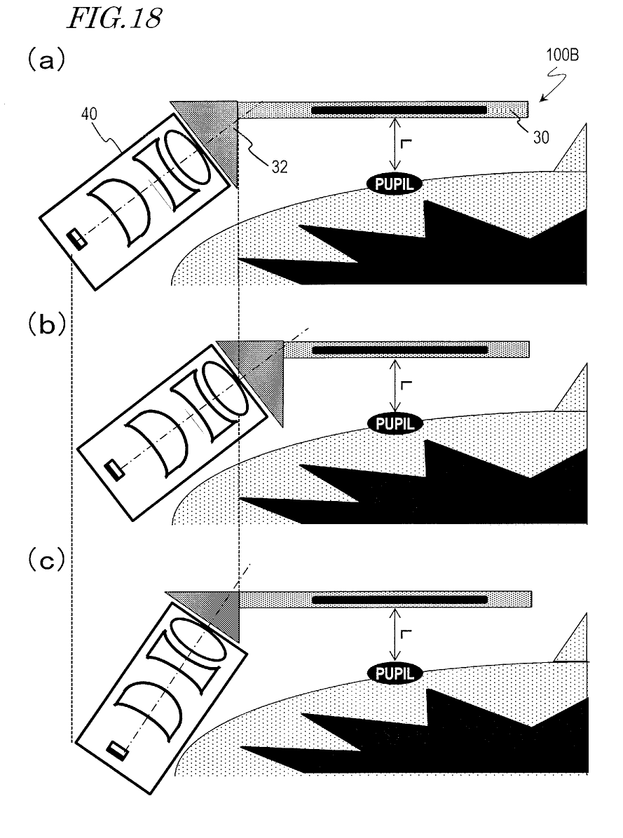

With reference to FIG. 16A to FIG. 17, and with special attention on virtual-image projection light from the center of the display element 10 of the virtual image projection device 40, behavior of a light beam in the light guide plate 30 will be described.

FIG. 16A schematically illustrates a cross section of the light guide plate 30 in the XZ plane. FIG. 16B schematically illustrates how light is reflected off the semi-reflective film 35r in a prism 35A. FIG. 16C and FIG. 16D schematically illustrate how the light is reflected off the semi-reflective film 35r in the prism 35A, with the horizontal angle of view (±θ_{H}) of the virtual image taken into account. The horizontal direction of the virtual image corresponds to the propagating direction of the virtual-image projection light in the light guide plate 30, i.e. the X direction. FIG. 17 schematically illustrates how the virtual-image projection light emitted from the display element 10 propagates through the interior of the light guide plate 30.

As in the first embodiment, the virtual-image projection light, which has been emitted from the center of the display element 10 and collimated, is introduced via the coupling structure 32 into the light guide plate 30 to propagate through the interior of the light guide plate 30 by repeating total reflections. The light beam propagating therein, upon reflection by the semi-reflective films 35r at the prism reflection array 35 of the light guide plate 30, exits through the outgoing surface S1 of the light guide plate 30 to the exterior. The outgoing light beam will reach the viewer's pupil. On the other hand, the light beam having been transmitted through the semi-reflective films 35r propagates through the interior of the light guide plate 30 again, so as to reach the prism reflection array 35.

If the virtual-image projection light exits in a direction substantially identical to the normal direction of the outgoing surface S1 of the light guide plate 30, then the viewer can perceive, in the substantial front, a virtual image that is based on the virtual-image projection light from the center of the display element 10. To this end, the relationship of eq. (9) needs to be satisfied between the incident angle (and reflection angle) 2φₛ of the virtual-image projection light with respect to the outgoing surface S1 of the light guide plate 30, and the slope angle φₚ of the first slope surfaces 35C, where nₛ denotes the refractive index of the transparent substrates, and nₚ denotes the refractive index of the light-guiding layer 33:

1≤nₛ·sin(2φₛ)=nₚ·sin(2φₚ). eq. (9)

Furthermore, with the horizontal angle of view (±θ_{H}) of the virtual image taken into account, there is also virtual-image projection light being incident on the light-guiding layer 33 of the light guide plate 30 at an angle of 2φₚ±θ_{Hp} with respect to the normal direction of the outgoing surface S3 of the light-guiding layer 33. Regarding this, eq. (10) holds true. In the present embodiment, the slope angle φₚ of the first slope surfaces 35C is chosen to be 26°, while the horizontal angle of view OH is chosen to be 10°. Note that, as in the first embodiment, the slope angle νₚ of the second slope surfaces 35D is preferably an angle which is near 90° so as to avoid unwanted deposition of stray vapor in oblique vapor deposition. In the present embodiment, the slope angle νₚ is chosen to be 85°:

sin(θ_{H})=nₚ·sin(θ_{Hp}) and 1≤nₚ·sin(2φₚ−θ_{H}). eq. (10)

As illustrated in FIG. 17, the virtual-image projection light from the center of the display element 10 propagates through the interior while undergoing total reflections at the incident angle 2φₛ off the upper and lower principal faces S1 and S2 of the light guide plate 30, and is reflected off the semi-reflective films of the prism reflection array 35 so as to reach the viewer. In order to allow the virtual-image projection light to exit in a direction substantially identical to the normal direction of the outgoing surface S1 of the light guide plate 30 so that the viewer can perceive the virtual image in the substantial front, the relationship of eq. (11) needs to hold true, where n_{c} denotes the refractive index of the coupling structure 32, and the angle 90−2φ_{c} is the incident angle of the virtual-image projection light on the interface (i.e., the end face S5) between the coupling structure 32 and the light guide plate 30:

1≤nₛ·sin(2φₛ)=nₚ·sin(2φₚ),

n_{c}·sin(90−2φ_{c})=nₛ·sin(90−2φₛ). eq. (11)

As in the present embodiment, when the optical axis of the virtual image projection device 40 is disposed so as to be perpendicular to the light-receiving surface of the coupling structure 32, the angle 2φ_{c} becomes equal to the slope angle α_{c} of the light-receiving surface of the coupling structure 32. As a result, eq. (11) may be transformed into eq. (12) using the slope angle α_{c}:

n_{c}·sin(90−α_{c})=nₛ·sin(90−2φₛ). eq. (12)

In the present embodiment, where the slope angle φₚ of the first slope surfaces 35C is set at 26°, if the refractive index n_{c} of the coupling structure 32, the refractive index nₛ of the transparent substrates, and the refractive index nₚ of the light-guiding layer 33 were equal to one another, then the slope angle α_{c} would become equal to the angle 2φₚ; as a result, the slope angle α, would become 52°. As mentioned earlier, this relationship between the refractive indices is disclosed in e.g. Patent Document 1.

On the other hand, from eq. (12), making the refractive index n_{c} of the coupling structure 32 smaller than the refractive index nₛ of the transparent substrates will allow the slope angle α_{c} to be decreased. Furthermore, according to eq. (11), making the refractive index nₛ of the transparent substrates greater than the refractive index nₚ of the light-guiding layer 33 will allow, in so far as the eq. (12) stays satisfied, the slope angle α_{c} to be decreased. In the present embodiment, the refractive index n_{c} of the transparent substrate is chosen to be 1.81, the refractive index n_{c} of the coupling structure 32 is chosen to be 1.53, and the refractive index nₚ of the light-guiding layer 33 is chosen to be 1.51. As a result, the slope angle α_{c} can be set at 26.9°, which is smaller than those in the first and second embodiments.

Note that the critical angle for the refractive index n_{c}=1.53 of the coupling structure 32 is 40.80. As a result, since the slope angle α_{c} (2φ_{c}) is smaller than the critical angle, a mirror M may preferably be provided on a face of the coupling structure 32 which is substantially parallel to the upper principal face S2 of the light guide plate 30, as illustrated in FIG. 17.

FIGS. 18(a) and (b) each schematically illustrate a relative positioning between a viewer and the virtual image projection device 40 as seen from above the viewer's head, where the viewer wears a virtual image display apparatus 100B having a light guide plate 30 in which the refractive index n_{c} of the coupling structure 32, the refractive index nₛ of the transparent substrates, and the refractive index nₚ of the light-guiding layer 33 coincide with one another. FIG. 18(c) schematically illustrates a relative positioning between the viewer and the virtual image projection device 40 as seen from above the viewer's head, where the viewer wears a virtual image display apparatus 100B having a light guide plate 30 in which the refractive index nₛ of the transparent substrates is greater than the respective refractive index n_{c} of the coupling structure 32 and the refractive index nₚ of the light-guiding layer 33.

As illustrated in FIG. 18(a), if the refractive index n_{c} of the coupling structure 32, the refractive index nₛ of the transparent substrates, and the refractive index nₚ of the light-guiding layer 33 coincided with one another, setting the slope angle φ of the first slope surfaces 35C at 26° might cause the slope angle α_{c} of the light-receiving surface of the coupling structure 32 to be set at 52°; in that case, trying to expand the peripheral field of view would end up causing the virtual image projection device 40 to protrude outside the virtual image display apparatus 100B being shaped like spectacles. The aesthetics of such a virtual image display apparatus 100B cannot be considered too good.

As illustrated in FIG. 18(b), trying in favor of aesthetics to prevent the virtual image projection device 40 from protruding outside would require the coupling structure 32 and the virtual image projection device 40 to be closer to the position of the viewer's pupil. As a result, they would end up partially blocking the field of view so as to narrow the field of view regarding the periphery.

As illustrated in FIG. 18(c), when the refractive index nₛ of the transparent substrates is greater than the refractive index nₚ of the light-guiding layer 33 and simultaneously the refractive index n_{c} of the coupling structure 32 is smaller than the refractive index nₛ of the transparent substrates, setting the slope angle φ of the first slope surfaces 35C at 26° allows the slope angle α_{c} of the light-receiving surface of the coupling structure 32 to be set at e.g. 26.9° as described earlier. In this case, even with the peripheral field of view kept wide, outward protrusion of the virtual image projection device 40 can be prevented; thus, there is provided a virtual image display apparatus 100B which conserves a viewer's field of view without detracting from aesthetics.

According to the present embodiment, a virtual image projection device 40 can be disposed so as to fit even more closely along a viewer's side face than according to the first and second embodiments.

The present specification discloses lightguides and virtual image display apparatuses as described in the following Items.

### [Item 1]

A lightguide comprising:

a coupling structure having a light-receiving surface to receive a light beam from a display element; and

a light guide plate which includes a first light-guiding layer having a prism surface that is disposed so as to partially transmit the light beam entering from the coupling structure and propagating therein, and which includes a second light-guiding layer covering the prism surface, the light guide plate having an outgoing surface via which the light beam having been transmitted through the prism surface is allowed to exit;

wherein a refractive index of the coupling structure is different from a refractive index of the light guide plate.

In accordance with the lightguide of Item 1, there is provided a lightguide which conserves a viewer's field of view without detracting from aesthetics.

### [Item 2]

The lightguide of Item 1, wherein,

the coupling structure is disposed either on the outgoing surface of the light guide plate or on an opposite surface that is opposite to the outgoing surface; and

the refractive index of the coupling structure is greater than the refractive index of the light guide plate.

With the lightguide of Item 2, an angle α_{c} which the light-receiving surface of the coupling structure forms with the outgoing surface of the light guide plate can be decreased relative to conventional lightguide structures.

### [Item 3]

The lightguide of Item 2, wherein,

the prism surface has a plurality of first and a plurality of second slope surfaces;

each of the plurality of first slope surfaces is inclined at a first slope angle φₚ with respect to the outgoing surface, and coated with a semi-reflective film which partially reflects a light beam propagating through an interior of the second light-guiding layer and partially transmits the light beam; each of the plurality of second slope surfaces is inclined at a second slope angle which is greater than the first slope angle φₚ with respect to the outgoing surface, and not coated with the semi-reflective film; and

the relationship α_{c}<2φₚ is satisfied between the first slope angle φₚ and an angle α_{c} which the light-receiving surface of the coupling structure forms with the outgoing surface of the light guide plate.

With the lightguide of Item 3, an angle α_{c} which the light-receiving surface of the coupling structure forms with the outgoing surface of the light guide plate can be decreased relative to conventional lightguide structures.

### [Item 4]

The lightguide of Item 2 or 3, wherein the refractive index of the coupling structure is greater than the respective refractive indices of the first light-guiding layer and the second light-guiding layer.

With the lightguide of Item 4, an angle α_{c} which the light-receiving surface of the coupling structure forms with the outgoing surface of the light guide plate can be decreased relative to conventional lightguide structures.

### [Item 5]

The lightguide of Item 1, wherein,

the light guide plate further includes a first transparent substrate supporting the first light-guiding layer and a second transparent substrate supporting the second light-guiding layer, the second transparent substrate having the outgoing surface at an opposite side from a contact surface via which the second transparent substrate is in contact with the second light-guiding layer;

the coupling structure contacts an end face of the light guide plate which is substantially orthogonal to a propagating direction of a light beam propagating through an interior of the light guide plate; and

the refractive index of the coupling structure is smaller than the refractive index of the light guide plate.

In accordance with the lightguide of Item 5, there is provided a variation of the lightguide that conserves a viewer's field of view without detracting from aesthetics.

### [Item 6]

The lightguide of Item 5, wherein the refractive index of the coupling structure is smaller than a refractive index of at least one of the first transparent substrate, the second transparent substrate, the first light-guiding layer, and the second light-guiding layer.

With the lightguide of Item 6, an angle α_{c} which the light-receiving surface of the coupling structure forms with the outgoing surface of the light guide plate can be further decreased relative to conventional lightguide structures.

### [Item 7]

The lightguide of Item 4, wherein the refractive index of the first light-guiding layer is substantially equal to the refractive index of the second light-guiding layer.

With the lightguide of Item 7, refraction and total reflection at the interface between the first and second light-guiding layers can be prevented.

### [Item 8]

The lightguide of any of Items 1 to 4 and 7, wherein the light guide plate further includes a first transparent substrate supporting the first light-guiding layer and a second transparent substrate supporting the second light-guiding layer, the second transparent substrate having the outgoing surface at an opposite side from a contact surface via which the second transparent substrate is in contact with the second light-guiding layer.

With the lightguide of Item 8, the strength and durability of the light guide plate can be enhanced, and also the light guide plate can be easily produced.

### [Item 9]

The lightguide of Item 8, wherein refractive indices of the first light-guiding layer, the second light-guiding layer, the first transparent substrate, and the second transparent substrate are substantially equal to one another.

With the lightguide of Item 9, refraction and total reflection at the interface between the light-guiding layers and at the interfaces between the transparent substrates and the light-guiding layers can be prevented.

### [Item 10]

The lightguide of Item 5 or 6, wherein,

the prism surface has a plurality of first and a plurality of second slope surfaces; and

each of the plurality of first slope surfaces is inclined at a first slope angle φₚ with respect to the outgoing surface, and coated with a semi-reflective film which partially reflects a light beam propagating through an interior of the second light-guiding layer and partially transmits the light beam; each of the plurality of second slope surfaces is inclined at a second slope angle which is greater than the first slope angle φₚ with respect to the outgoing surface, and not coated with the semi-reflective film.

### [Item 11]

The lightguide of Item 6, wherein the refractive index of the first light-guiding layer is substantially equal to the refractive index of the second light-guiding layer while the refractive index of the first transparent substrate is substantially equal to the refractive index of the second transparent substrate.

With the lightguide of Item 11, the first and second light-guiding layers can be made of an identical material, and simultaneously the first and second transparent substrates can be made of an identical material.

### [Item 12]

The lightguide of Item 11, wherein the refractive indices of the first and second transparent substrates are greater than the refractive indices of the first and second light-guiding layers.

### [Item 13]

The lightguide of any of Items 1 to 12, wherein the second light-guiding layer is a planarization layer for planarizing the lens surface, the planarization layer having a substantially flat surface.

With the lightguide of Item 13, producibility of light guide plates can be provided.

### [Item 14]

The lightguide of any of Items 1 to 13, wherein the coupling structure and the light guide plate are mutually independent members.

With the lightguide of Item 14, the members can be independently produced, thereby allowing to incorporate members which have distinct refractive indices.

### [Item 15]

A virtual image display apparatus comprising:

an image processing circuit to horizontally reduce an input image;

the display element to display the reduced image having been horizontally reduced;

a collimating optical system to collimate displaying light emitted from the display element; and

the lightguide of any of Items 2 to 4 and 7 to 9.

With the virtual image display apparatus of Item 15, the aspect ratio of a virtual image to be viewed on the virtual image display apparatus can be made identical to that of the original input image.

### [Item 16]

A virtual image display apparatus comprising:

the display element;

a collimating optical system to collimate displaying light emitted from the display element; and

the lightguide of any of Items 1 to 14.

In accordance with the virtual image display apparatus of Item 16, there is provided a virtual image display apparatus incorporating a lightguide which conserves a viewer's field of view without detracting from aesthetics.

### INDUSTRIAL APPLICABILITY

A lightguide according to embodiments of the present invention is suitably applicable to an HMD, an HUD, or any other virtual image display apparatus or the like.

### INCORPORATION BY REFERENCE

The present application claims priority to Japanese Patent Application No. 2015-218504, filed on Nov. 6, 2015, the entire disclosure of which is incorporated herein by reference.

### REFERENCE SIGNS LIST

10 display element
20 projection lens system
30 light guide plate
32 coupling structure
33 light-guiding layer
33A first light-guiding layer
33B second light-guiding layer
34A first transparent substrate
34B second transparent substrate
35 prism reflection array
35r semi-reflective film
40 virtual image projection device
50 image processing circuit
100, 100A, 100B virtual image display apparatus
200 die

1. A lightguide comprising:
a coupling structure having a light-receiving surface to receive a light beam from a display element; and
a light guide plate which includes a first light-guiding layer having a prism surface that is disposed so as to partially transmit the light beam entering from the coupling structure and propagating therein, and which includes a second light-guiding layer covering the prism surface, the light guide plate having an outgoing surface via which the light beam having been transmitted through the prism surface is allowed to exit;
wherein a refractive index of the coupling structure is different from a refractive index of the light guide plate.

2. The lightguide of claim 1, wherein,
the coupling structure is disposed either on the outgoing surface of the light guide plate or on an opposite surface that is opposite to the outgoing surface; and
the refractive index of the coupling structure is greater than the refractive index of the light guide plate.

3. The lightguide of claim 2, wherein,
the prism surface has a plurality of first and a plurality of second slope surfaces;
each of the plurality of first slope surfaces is inclined at a first slope angle φₚ with respect to the outgoing surface, and coated with a semi-reflective film which partially reflects a light beam propagating through an interior of the second light-guiding layer and partially transmits the light beam; each of the plurality of second slope surfaces is inclined at a second slope angle which is greater than the first slope angle φₚ with respect to the outgoing surface, and not coated with the semi-reflective film; and
the relationship α_{c}<2φₚ is satisfied between the first slope angle φₚ and an angle α_{c} which the light-receiving surface of the coupling structure forms with the outgoing surface of the light guide plate.

4. The lightguide of claim 2, wherein the refractive index of the coupling structure is greater than the respective refractive indices of the first light-guiding layer and the second light-guiding layer.

5. The lightguide of claim 1, wherein,
the light guide plate further includes a first transparent substrate supporting the first light-guiding layer and a second transparent substrate supporting the second light-guiding layer, the second transparent substrate having the outgoing surface at an opposite side from a contact surface via which the second transparent substrate is in contact with the second light-guiding layer;
the coupling structure contacts an end face of the light guide plate which is substantially orthogonal to a propagating direction of a light beam propagating through an interior of the light guide plate; and
the refractive index of the coupling structure is smaller than the refractive index of the light guide plate.

6. The lightguide of claim 5, wherein the refractive index of the coupling structure is smaller than a refractive index of at least one of the first transparent substrate, the second transparent substrate, the first light-guiding layer, and the second light-guiding layer.

7. The lightguide of claim 4, wherein the refractive index of the first light-guiding layer is substantially equal to the refractive index of the second light-guiding layer.

8. The lightguide of claim 1, wherein the light guide plate further includes a first transparent substrate supporting the first light-guiding layer and a second transparent substrate supporting the second light-guiding layer, the second transparent substrate having the outgoing surface at an opposite side from a contact surface via which the second transparent substrate is in contact with the second light-guiding layer.

9. The lightguide of claim 8, wherein refractive indices of the first light-guiding layer, the second light-guiding layer, the first transparent substrate, and the second transparent substrate are substantially equal to one another.

10. The lightguide of claim 5, wherein,
the prism surface has a plurality of first and a plurality of second slope surfaces; and
each of the plurality of first slope surfaces is inclined at a first slope angle φₚ with respect to the outgoing surface, and coated with a semi-reflective film which partially reflects a light beam propagating through an interior of the second light-guiding layer and partially transmits the light beam; each of the plurality of second slope surfaces is inclined at a second slope angle which is greater than the first slope angle φₚ with respect to the outgoing surface, and not coated with the semi-reflective film.

11. The lightguide of claim 6, wherein the refractive index of the first light-guiding layer is substantially equal to the refractive index of the second light-guiding layer while the refractive index of the first transparent substrate is substantially equal to the refractive index of the second transparent substrate.

12. The lightguide of claim 11, wherein the refractive indices of the first and second transparent substrates are greater than the refractive indices of the first and second light-guiding layers.

13. The lightguide of claim 1, wherein the second light-guiding layer is a planarization layer for planarizing the prism surface, the planarization layer having a substantially flat surface.

14. The lightguide of claim 1, wherein the coupling structure and the light guide plate are mutually independent members.

15. A virtual image display apparatus comprising:
an image processing circuit to horizontally reduce an input image;
the display element to display the reduced image having been horizontally reduced;
a collimating optical system to collimate displaying light emitted from the display element; and
the lightguide of claim 2.

16. A virtual image display apparatus comprising:
the display element;
a collimating optical system to collimate displaying light emitted from the display element; and
the lightguide of claim 1.
